(19) United States
(12) Patent Application Publication
(10) Pub. No.: US 2011/0197008 A1
(43) Pub. Date: Aug. 11, 2011

(54) CARD HOST LSI AND SET DEVICE INCLUDING THE LSI

(75) Inventors: Rie ITOU, Osaka (JP); Makoto Fujiwara, Kyoto (JP); Takehisa Hirano, Osaka (JP); Koichiro Fue, Osaka (JP)

(73) Assignee: PANASONIC CORPORATION, Osaka (JP)

(21) Appl. No.: 13/089,985

(22) Filed: Apr. 19, 2011

Related U.S. Application Data
(63) Continuation of application No. PCT/JP2009/005367, filed on Oct. 14, 2009.

(30) Foreign Application Priority Data
Oct. 24, 2008 (JP) 2008-274575
Jul. 14, 2009 (JP) 2009-165517

(51) Int. Cl. G06F 13/14

(52) U.S. Cl. 710/301

(57) ABSTRACT

A card host LSI includes M card host I/Fs for N-bit card modules, and M card bus terminals. A bridge circuit sets coupling relationship of signal lines so that a card host I/F corresponding to a card bus coupled to an (M×N)-bit card module and the other card host I/F(s) operate in conjunction with each other to control the card module, when an enable signal indicates the (M×N)-bit mode.

### CROSS-REFERENCE TO RELATED APPLICATION

This is a continuation of PCT International Application PCT/JP2009/005367 filed on Oct. 14, 2009, which claims priority to Japanese Patent Application No. 2008-274575 filed on Oct. 24, 2008, and Japanese Patent Application No. 2009-165517 filed on Jul. 14, 2009. The disclosures of these applications including the specifications, the drawings, and the claims are hereby incorporated by reference in their entirety.

### BACKGROUND

The present disclosure relates to card host LSIs having the function of controlling removable cards such as SD cards and embedded modules (hereinafter referred to as card modules) for the removable cards, and set devices including the card host LSIs.

With start of widespread use of multimedia in portable devices, removable cards such as SD cards are widely used in mobile phone terminals etc. as external memory media. In recent years, embedded modules such as embedded SDs (eSDs) have been included in mobile phone terminals etc. as a type of internal memory devices.

Conventionally, card host LSIs controlling such card modules have input and output terminals for inputting and outputting data in number equal to the number of those in a card module having the most terminals to accept a plurality of types of card module with various forms and specifications (see, e.g., Japanese Patent Publication No. 2004-280808).

Also, in recent years, a single card host LSI or a plurality of card host LSIs is/are required, which control(s) a plurality of card modules for copies among the card modules, capacity expansion of card modules, etc. (see, e.g., Japanese Patent Publication No. 2008-134701).

### SUMMARY

FIGS. 25 and 26 illustrate example configurations of a set device using a conventional card host LSI.

A set device 500 shown in FIG. 25 includes a main microcomputer 50, a card host LSI 501, a card bus 503, and a card slot S505a. The card host LSI 501 includes a host I/F 51 and a card host I/F 502a. The card slot S505a accepts both of an SD card 505a for 4 bits and a multi-media card (MMC) 515a for 8 bits. In general, a data line of an SD card has a 4-bit width, and a data line of an MMC has a 4-bit width and an 8-bit width. The set device 500 shown in FIG. 25 accepts the single SD card 505a or the single MMC 515a.

A set device 500A shown in FIG. 26 includes a main microcomputer 50, a card host LSI 501A, card busses 503 and 504, and card slots S505a and S505b. The card host LSI 501A includes a host I/F 51 and card host I/Fs 502a and 502b. That is, the configuration of FIG. 26 includes the card host I/F 502b and the card slot S505b in addition to the configuration of FIG. 25. Similarly, the card slot S505b accepts both of an SD card 505b for 4 bits and an MMC 515b for 8 bits. Different from the set device of FIG. 25, the set device 500A shown in FIG. 26 accepts two SD cards 505a and 505b, or two M_MCs 515a and 515b.

The card host I/Fs 502a and 502b respectively include registers R502a and R502b, and buffers B502a and B502b with FIFO structures. The card bus 503 includes a clock line 503a, a command line 503b, and a plurality of (herein eight) data lines 503c. The card bus 504 includes a clock line 504a, a command line 504b, and a plurality of (herein eight) data lines 504c. The main microcomputer 50 makes access to the registers R502a and R502b thereby independently controlling card modules via the two card host I/Fs 502a and 502b.

The number of data lines of a card host I/F is equal to that of a card module having the most data lines among a corresponding plurality of card modules. However, in a conventional configuration, some data lines are not in use and redundant when using a card module other than the card module having the most data lines.

In recent years, controlling a plurality of card modules is the mainstream. In this case, the number of the input and output terminals coupled to data lines increases in proportion to the number of the card modules when preparing data lines in number equal to the largest number of data lines in each card module. This increases the mounting area and costs.

In view of the problem, it is an objective of the present disclosure to reduce the number of the input and output terminals in a card host LSI capable of controlling a plurality of types of card modules.

According to a first aspect of the present disclosure, a card host LSI has a function of controlling a plurality of card modules each of which is a removable card or an embedded module. The card host LSI includes M card host I/Fs, where M is an integer of two or more, for N-bit card modules, where N is an integer of one or more, and controlled from outside the card host LSI; M card bus terminals respectively corresponding to the M card host I/Fs and respectively coupled to M card busses outside the card host LSI; and a bridge circuit provided between the M card host I/Fs and the M card bus terminals and configured to set coupling relationship of signal lines between the M card host I/Fs and the M card bus terminals. The bridge circuit receives an enable signal indicating whether or not the card host LSI is in an (M×N)-bit mode for controlling an (M×N)-bit card module, and sets the coupling relationship of the signal lines so that a first card host I/F corresponding to a card bus coupled to the (M×N)-bit card module and the other card host I/F(s) operate in conjunction with each other to control the (M×N)-bit card module, when the enable signal indicates the (M×N)-bit mode.

According to the first aspect, since the M card host I/Fs for the N-bit card modules are provided, the card host LSI can control M N-bit card modules. The bridge circuit sets the coupling relationship of the signal lines between the card host I/Fs and the card bus terminals so that the card host I/F coupled to the (M×N)-bit card module and the other card host I/F(s) operate in conjunction with each other to control the (M×N)-bit card module, in the (M×N)-bit mode. This enables control of the (M×N)-bit card module using the M card host I/Fs for N bits. That is, there is no need to provide a dedicated card bus terminal to control the (M×N)-bit card module, thereby reducing the number of the input and output terminals. Furthermore, since there is no need to provide any card host I/F for the (M×N)-bit card module, the circuit size does not increase, thereby mitigating an increase in the area of the card host LSI.

In the card host LSI according to the first aspect, each of the card busses preferably includes as signal lines, a data line for transmitting and receiving data, a command line for transmitting a command and receiving a response, and a clock line for transmitting a clock. The bridge circuit preferably sets the coupling relationship of the signal lines so that a clock and a command output from the card host I/F(s) other than the first card host I/F are not transmitted to the card busses, when the enable signal indicates the (M×N)-bit mode.

With this feature, in the (M×N)-bit mode, the clock and the command output from the card host I/F(s) other than the card host I/F coupled to the (M×N)-bit card module are not transmitted to the card busses.

In the card host LSI according to the first aspect, each of the card busses preferably includes as signal lines, a data line for transmitting and receiving data, a command line for transmitting a command and receiving a response, and a clock line for transmitting a clock. The bridge circuit preferably sets the coupling relationship of the signal lines so that a response from the (M×N)-bit card module is returned to the first card host I/F as well as the other card host I/F(s), when the enable signal indicates the (M×N)-bit mode.

With this feature, in the (M×N)-bit mode, the response from the (M×N)-bit card module is also returned to the card host I/F(s) other than the card host I/F coupled to the (M×N)-bit card module. This reduces response errors caused by lack of a response.

In the card host LSI according to the first aspect, each of the M card host I/Fs preferably includes a response determination circuit configured to determine validity of a response to a command. The function of the response determination circuit in the card host I/F(s) other than the first card host I/F is preferably disabled in the (M×N)-bit mode.

With this feature, the function of determining the validity of the response in the card host I/F(s) other than the card host I/F coupled to the (M×N)-bit card module is disabled in the (M×N)-bit mode. This reduces response errors caused by lack of a response.

In the card host LSI according to the first aspect, the card host I/F(s) other than the first card host I/F is preferably set to notify only an error interrupt of transmitted data among occurring interrupts in the (M×N)-bit mode.

With this feature, in the (M×N)-bit mode, the card host I/F(s) other than the card host I/F coupled to the (M×N)-bit card module is set to notify only the error interrupt of the transmitted data. This reduces duplicate output of the same interrupts from the card host I/F coupled to the (M×N)-bit card module and the other card host I/F(s).

In the card host LSI according to the first aspect, each of the card busses preferably includes as signal lines, a data line for transmitting and receiving data, a command line for transmitting a command and receiving a response, and a clock line for transmitting a clock. The bridge circuit preferably sets the coupling relationship of the signal lines so that status information indicating a status of the (M×N)-bit card module is returned to the first card host I/F as well as the other card host I/F(s), when the enable signal indicates the (M×N)-bit mode.

With this feature, in the (M×N)-bit mode, the status information indicating the status of the (M×N)-bit card module is also returned to the card host I/F(s) other than the card host I/F coupled to the (M×N)-bit card module. This easily continues conjunction operation of the card host I/F coupled to the (M×N)-bit card module and the other card host I/F(s).

The card host LSI according to the first aspect preferably further includes a host I/F configured to receive a control signal from outside the card host LSI, and a bit rearrangement circuit provided between the host I/F and the M card host I/Fs. The bit rearrangement circuit receives the enable signal, and rearranges bits of data written to the M card host I/Fs via the host I/F so that the first card host I/F and the other card host I/F(s) operate in conjunction with each other to write data to the (M×N)-bit card module, when the enable signal indicates the (M×N)-bit mode.

With this feature, there is no need to rearrange the data with the main microcomputer located outside the card host LSI and output the data to the card host LSI, thereby reducing the load of the main microcomputer. That is, the bits are rearranged by hardware, thereby increasing speed and reducing power consumption.

The card host LSI according to the first aspect preferably further includes an enable register configured to store the enable signal.

The card host LSI according to the first aspect preferably further includes a high-speed startup sequencer starting in turning on the card host LSI. The high-speed startup sequencer preferably determines whether or not the (M×N)-bit card module is coupled to the card host LSI, and when coupled, preferably sets the enable signal stored in the enable register to indicate the (M×N)-bit mode.

With this feature, the high-speed startup sequencer inside the card host LSI controls the (M×N)-bit mode, thereby reducing the load when starting up the main microcomputer provided outside the card host LSI. Also, the control is performed by hardware. This allows start-up at high speed, and there is no need to boot the main microcomputer in advance, thereby reducing power consumption.

Furthermore, the high-speed startup sequencer preferably sets the enable signal stored in the enable register not to indicate the (M×N)-bit mode, when another card module is coupled to the card host LSI together with the (M×N)-bit card module.

With this feature, when the (M×N)-bit card module and another card module are coupled to the card host LSI, the (M×N)-bit card module is controlled by the N bit mode, thereby using both of the card modules.

In the card host LSI according to the first aspect, M=2, for example.

The card host LSI according to the first aspect preferably further includes two or more sets of the M card host I/Fs, the M card bus terminals, and the bridge circuit; and a second card host I/F. The second card host I/F preferably controls the card module via unused one(s) of the M card bus terminals in the (M×N)-bit mode.

With this feature, in the (M×N)-bit mode, the second card host I/F controls the card module via the unused portion of the card bus terminals. This increases controllable card module without newly adding any card bus terminal.

According to a second aspect of the present disclosure, a set device includes the card host LSI of the first aspect; a main microcomputer configured to configure the card host LSI; and M card slots or M embedded modules respectively coupled to the M card bus terminals of the card host LSI.

In the set device according to the second aspect, the main microcomputer does not preferably set the card host LSI to the (M×N)-bit mode, when another card module is coupled to the card host LSI together with the (M×N)-bit card module.

According to a third aspect of the present disclosure, a card host LSI having a function of controlling a plurality of card modules each of which is a removable card or an embedded module. The card host LSI includes M card host I/Fs, where M is an integer of two or more, for Ni-bit card modules, where i ranges from 1 to M and Ni is an integer of 1 or more, and controlled from outside the card host LSI; M card bus terminals respectively corresponding to the M card host I/Fs and respectively coupled to M card busses outside the card host LSI; and a bridge circuit provided between the M card host I/Fs and the M card bus terminals and configured to set coupling relationship of signal lines between the M card host I/Fs and the M card bus terminals. The bridge circuit receives an enable signal indicating whether or not the card host LSI is in an L-bit mode, where L is an integer of two or more, for controlling an L-bit card module with a plurality of card host I/Fs; and sets the coupling relationship of the signal lines so that a card host I/F corresponding to a card bus coupled to the L-bit card module and the other card host I/F(s) operate in conjunction with each other to control the L-bit card module, when the enable signal indicates the L-bit mode.

According to the third aspect, since the M card host I/Fs for the Ni-bit card modules are provided, the card host LSI controls the M card modules. The bridge circuit sets the coupling relationship of the signal lines between the card host I/Fs and the card bus terminals so that the card host I/F coupled to the L-bit card module and the other card host I/F(s) operate in conjunction with each other to control the L-bit card module in the L bit mode. This enables control of the L-bit card module using the plurality of card host I/Fs. That is, there is no need to provide any dedicated card bus terminal to control the L-bit card module, thereby reducing the number of the input and output terminals. Furthermore, since there is no need to provide any card host I/F for an L-bit card module, the circuit size does not increase, thereby mitigating an increase in the area of the card host LSI.

According to a fourth aspect of the present disclosure, a card host LSI has a function of controlling a plurality of card modules each of which is a removable card or an embedded module. The card host LSI includes M card host I/Fs, where M is an integer of 2 or more, for N-bit card modules, where N is an integer of 1 or more, and controlled from outside the card host LSI; M card bus terminals respectively corresponding to the M card host I/Fs and respectively coupled to M card busses outside the card host LSI; a host I/F configured to receive a control signal from outside the card host LSI; and a bridge circuit provided between the M card host I/Fs and the host I/F, configured to provide the M card host I/Fs with the control signal received via the host I/F, and configured to perform setting of the M card host I/Fs. The bridge circuit receives an enable signal indicating whether or not the card host LSI is in an (M×N)-bit mode for controlling an (M×N)-bit card module, and sets the M card host I/Fs so that a first card host I/F corresponding to a card bus coupled to the (M×N)-bit card module and the other card host I/F(s) operate in conjunction with each other to control the (M×N)-bit card module, when the enable signal indicates the (M×N)-bit mode.

According to the fourth aspect, since the M card host I/Fs for the N-bit card modules are provided, the card host LSIs can control the M N-bit card modules. The bridge circuit sets the M card host I/Fs so that the card host I/F coupled to the (M×N)-bit card module and the other card host I/F(s) operate in conjunction with each other to control the (M×N)-bit card module in the (M×N)-bit mode. This enables control of the (M×N)-bit card module using the M card host I/Fs for N bits. That is, there is no need to provide a dedicated card bus terminal to control the (M×N)-bit card module, thereby reducing the number of the input and output terminals. Furthermore, there is no need to provide any card host I/F for the (M×N)-bit card module, the circuit size does not increase, thereby mitigating an increase in the area of the card host LSI.

According to a fifth aspect of the present disclosure, a set device includes the card host LSI according to the fourth aspect; a main microcomputer configured to configure the card host LSI; and M card slots or M embedded module respectively coupled to the M card bus terminals of the card host LSI.

According to a sixth aspect of the present disclosure, a card host LSI has a function of controlling a plurality of card modules each of which is a removable card or an embedded module. The card host LSI includes M card host I/Fs, where M is an integer of two or more, for Ni-bit card modules, where i ranges from 1 to M and Ni is an integer of 1 or more, and controlled from outside the card host LSI; M card bus terminals respectively corresponding to the M card host I/Fs and respectively coupled to M card busses outside the card host LSI; a host I/F configured to receive a control signal from outside the card host LSI; and a bridge circuit provided between the M card host I/Fs and the host I/F, configured to provide the M card host I/Fs with the control signal received via the host I/F, and configured to perform setting of the M card host I/Fs. The bridge circuit receives an enable signal indicating whether or not the card host LSI is in an L-bit mode, where L is an integer of two or more, for controlling an L-bit card module with a plurality of card host I/Fs, and sets the M card host I/Fs so that a card host I/F corresponding to a card bus coupled to the L-bit card module and the other card host I/F(s) operate in conjunction with each other to control the L-bit card module, when the enable signal indicates the L-bit mode.

According to the sixth aspect, since the M card host I/Fs for the Ni-bit card modules are provided, the card host LSI can control the M card modules. The bridge circuit sets the M card host I/Fs so that the card host I/F coupled to the L-bit card module and the other card host I/F(s) operate in conjunction with each other to control the L-bit card module in the L-bit mode. This enables control of the L-bit card module using the plurality of card host I/Fs. That is, there is no need to provide any dedicated card bus terminal to control the L-bit card module, thereby reducing the number of the input and output terminals. Furthermore, since there is no need to provide any card host I/F for the L-bit card module, the circuit size does not increase, thereby mitigating an increase in the area of the card host LSI.

As described above, according to the present disclosure, a plurality of card host I/Fs operate in conjunction with each other, thereby controlling a card module with a bit width different from a bit width of individual card host I/Fs. This reduces the number of the input and output terminals and mitigates an increase in an area, thereby reducing costs.

### BRIEF DESCRIPTION OF THE DRAWINGS

FIG. 1 illustrates a configuration of a set device according to a first embodiment.

FIG. 2 illustrates that an MMC for 8 bits is coupled in the configuration of FIG. 1.

FIG. 3 illustrates a detailed configuration of a bridge circuit of FIG. 1 and its surroundings.

FIGS. 4A and 4B are timing charts in block writing where an MMC for 8 bits is coupled.

FIGS. 5A-5C illustrate bit rearrangement of a bit rearrangement circuit where an MMC for 8 bits is coupled.

FIG. 6 is a variation of FIG. 3.

FIG. 7 illustrates that a card host LSI controls an embedded module in the first embodiment.

FIG. 8 illustrates a configuration of a set device according to a second embodiment.

FIG. 9 illustrates a detailed configuration of a bridge circuit of FIG. 8 and its surroundings.

FIG. 10 illustrates a configuration of a set device according to a third embodiment.

FIG. 11 illustrates a configuration of a set device according to a variation of the first embodiment.

FIG. 12 illustrates a configuration of a set device according to a variation of the first embodiment.

FIG. 13 illustrates a configuration of a set device according to a fourth embodiment.

FIG. 14 illustrates a detailed configuration of a bridge circuit of FIG. 13 and its surroundings.

FIGS. 15A-15C illustrate an example configuration of a register included in a card host I/F.

FIGS. 16A-16C illustrate an example configuration of a register included in a card host I/F.

FIG. 17 illustrates a detailed configuration of a #A access control circuit of FIG. 14. FIGS. 18A and 18B are timing charts illustrating operation of the #A access control circuit of FIG. 17.

FIG. 19 illustrates a detailed configuration of a #B access control circuit of FIG. 14.

FIGS. 20A and 20B are timing charts illustrating operation of the #B access control circuit of FIG. 19.

FIG. 21 illustrates a configuration of a set device according to a fifth embodiment.

FIGS. 22A and 22B are timing charts illustrating operation of a timing control circuit of FIG. 21.

FIG. 23 illustrates a configuration of a set device according to a sixth embodiment.

FIGS. 24A and 24B are timing charts illustrating operation of a timing control circuit of FIG. 23.

FIG. 25 illustrates a configuration of a set device including a conventional card host LSI.

FIG. 26 illustrates a configuration of a set device including a conventional card host LSI.

### DETAILED DESCRIPTION

Embodiments of the present disclosure will be described hereinafter with reference to the drawings.

### First Embodiment

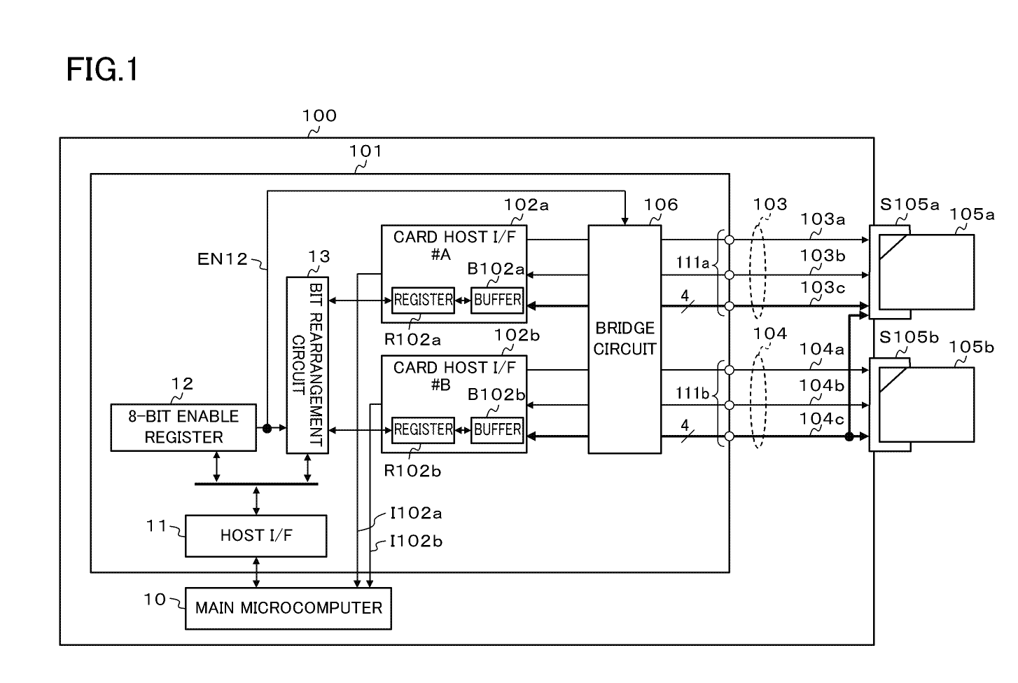

FIG. 1 illustrates a configuration of a set device according to a first embodiment. The set device according to this embodiment has the function of controlling MMCs and SD cards as examples of removable cards, and embedded modules conforming to the card bus specifications of the MMCs and the SD cards. The set device according to the present disclosure is, for example, a mobile phone terminal. This is applicable to the subsequent embodiments.

As shown in FIG. 1, a set device 100 includes a main microcomputer 10, a card host LSI 101, card busses 103 and 104, and card slots S105a and S105b. The card host LSI 101 has the function of controlling a plurality of (two in FIG. 1) card modules which are removable cards or embedded modules. In FIG. 1, removable SD cards 105a and 105b for 4 bits are inserted into the card slots S105a and S105b.

The card host LSI 101 includes a host I/F 11 receiving a control signal from outside, two card host I/Fs 102a (#A) and 102b(#B), and two card bus terminals 111a and 111b. Each of the card host I/Fs 102a and 102b has the function as an independent card master, accepts a 4-bit card module, and is controlled from the main microcomputer 10 via the host I/F 11. The card bus terminals 111a and 111b respectively correspond to the card host I/Fs 102a and 102b, and are respectively coupled to the card busses 103 and 104.

The card bus 103 includes a clock line 103a, a command line 103b, and a 4-bit data line 103c, and is coupled to the card slot S105a. The card bus 104 includes a clock line 104a, a command line 104b, and a 4-bit data line 104c, and is coupled to the card slot S105b. The clock lines 103a and 104a are signal lines for transmitting clocks to the card slots S105a and S105b. The command lines 103b and 104b are signal lines for transmitting commands to the card slots S105a and S105b, and receiving responses from the card slots S105a and S105b. The data lines 103c and 104c are signal lines for transmitting and receiving data. Furthermore, in this embodiment, the data line 104c of the card bus 104 is coupled not only to the card slot S105b, but also to the card slot S105a.

The card host I/Fs 102a and 102b respectively include registers R102a and R102b, and buffers B102a and B102b having FIFO structures. The card host I/Fs 102a and 102b notify the main microcomputer 10 of responses from the card slots S105a and S105b, CRC errors, etc. with interrupt signals I102a and I102b.

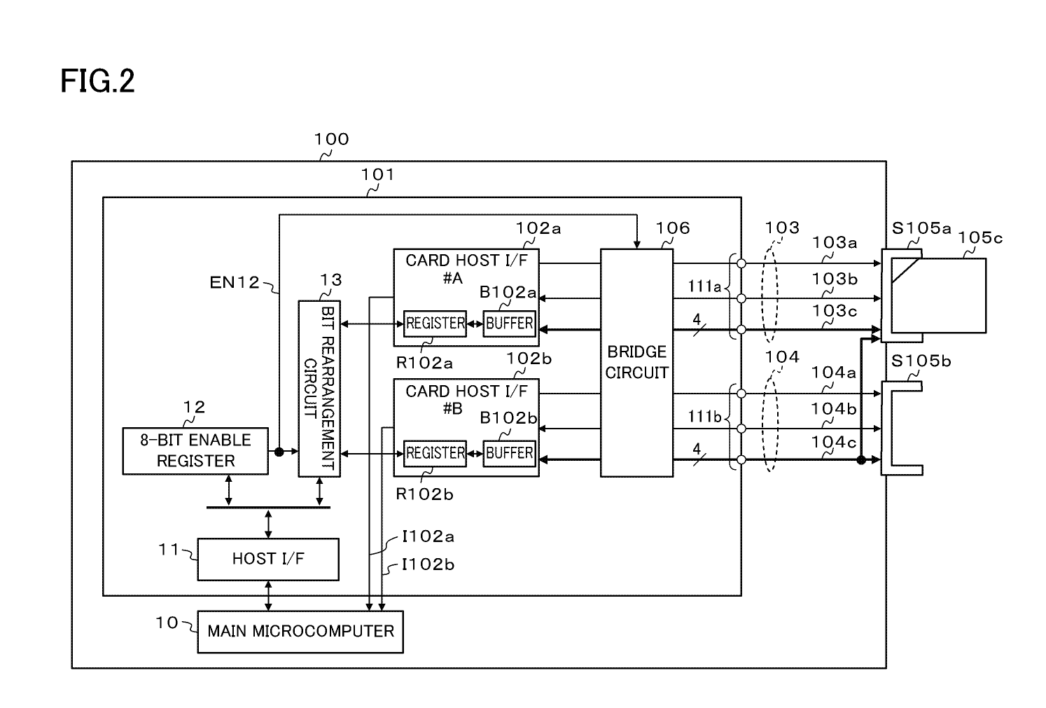

Moreover, in this embodiment, the card host LSI 101 also accepts 8-bit card modules. FIG. 2 illustrates that an M_MC105c for 8 bits is inserted into the card slot S105a of the set device 100 of FIG. 1. That is, the card host LSI 101 controls an 8-bit card module without using any dedicated card bus terminal.

Specifically, the card host LSI 101 further includes an 8-bit enable register 12, a bit rearrangement circuit 13, and a bridge circuit 106. The 8-bit enable register 12 stores an enable signal EN12 indicating whether or not the card host LSI 101 is an 8-bit mode for controlling an 8-bit card module. When the enable signal EN12 is asserted, the card host LSI 101 is in an 8-bit mode. When the enable signal EN12 is negated, the card host LSI 101 is not in an 8-bit mode. The enable signal EN12 is transmitted to the bit rearrangement circuit 13 and the bridge circuit 106. Note that the 8-bit enable register 12 may be located inside the host I/F 11.

The bridge circuit 106 is provided between the card host I/Fs 102a and 102b, and the card bus terminals 111a and 111b; and sets coupling relationship of signal lines between the card host I/Fs 102a and 102b, and the card bus terminals 111a and 111b. Specifically, when the enable signal EN12 is asserted, the card host I/F 102a as a first card host I/F corresponding to the card bus 103 coupled to an 8-bit card module, and the other card host I/F 102b operate in conjunction with each other to set the coupling relationship of the signal lines to control the 8-bit card module.

The bit rearrangement circuit 13 is provided between the host I/F 11 and the card host I/Fs 102a and 102b. When the enable signal EN12 is asserted, the bit rearrangement circuit 13 rearranges bits of data written to the card host I/Fs 102a and 102b via the host I/F 11 so that the card host I/Fs 102a and 102b operate in conjunction with each other to write the data to the 8-bit card module.

Specifically, when the enable signal EN12 is negated and the main microcomputer 10 sets a command and an argument at each of the card host I/Fs 102a and 102b, the bit rearrangement circuit 13 writes the command and the argument to each of the register R102a and R102b. Similarly, when writing data, the data is written to the buffers B102a and B102b. On the other hand, when the enable signal EN12 is asserted, and the main microcomputer 10 sets a command and an argument at the card host I/F 102a, the same commands and arguments are written to the register R102a and R102b. When writing data, the data with rearranged bits, which will be described later, is written to the buffers B102a and B102b. When reading data, the data with the original order of bits is read from each of the buffers B102a and B102b.

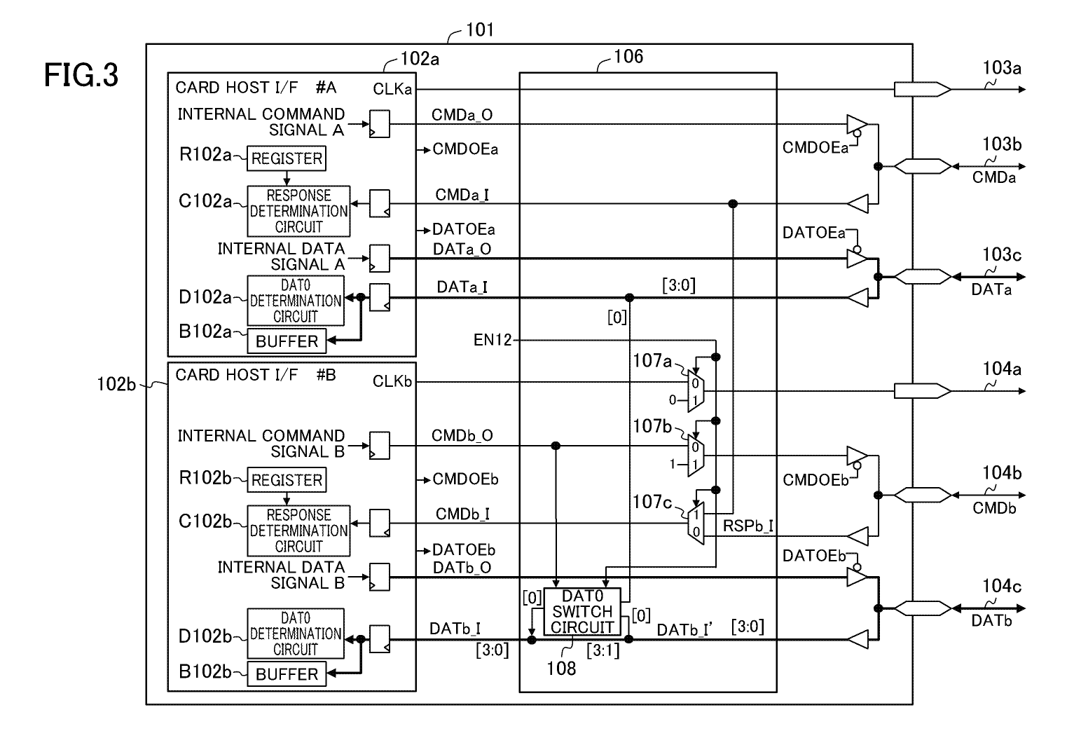

FIG. 3 illustrates a detailed configuration of the bridge circuit 106 and its surroundings. As shown in FIG. 3, the bridge circuit 106 includes selectors 107a, 107b, and 107c, and a DAT0 switch circuit 108. The selectors 107a, 107b, and 107c, and the DAT0 switch circuit 108 are controlled with the enable signal EN12.

The selector 107a switches between outputs to the clock line 104a. Specifically, the selector 107a selects a clock output from the card host I/F 102b when the enable signal EN12 is negated, and selects a fixed value “0” when the enable signal EN12 is asserted. The selector 107b switches between outputs to the command line 104b. Specifically, the selector 107b selects a command output from the card host I/F 102b when the enable signal EN12 is negated, and selects a fixed value “1” when the enable signal EN12 is asserted. When the enable signal EN12 is asserted, i.e., when the enable signal EN12 indicates an 8-bit mode, the operation of the selectors 107a and 107b sets the coupling relationship of the signal lines so that the clock and the command output from the card host I/F 102b are not transferred to the card bus 104. Due to this configuration, the clock and the command output from the card host I/F 102b are not transferred to the card bus 104.

The selector 107c switches between responses returned to the card host I/F 102b. Specifically, the selector 107c selects a response input from the command line 104b when the enable signal EN12 is negated, and selects a response input from the command line 103b coupled to the 8-bit card module when the enable signal EN12 is asserted. When the enable signal EN12 is asserted, i.e., when the enable signal EN12 indicates an 8-bit mode, the operation of the selector 107c sets the coupling relationship of the signal lines so that a response from the 8-bit card module is returned to the card host I/F 102a as well as the card host I/F 102b. This reduces response errors caused by lack of a response in the card host I/F 102b.

The DAT0 switch circuit 108 switches between bit 0 of data input to the card host I/F 102b. Specifically, the DAT0 switch circuit 108 selects bit 0 of data input from the data line 104c when the enable signal EN12 is negated. Where the enable signal EN12 is asserted, the DAT0 switch circuit 108 selects bit 0 of data input from the data line 103c only when the command CMDb_O is a write command. In this embodiment, a cyclic redundancy check (CRC) status and a busy signal as status information indicating the status of the 8-bit card module are transmitted as bit 0 of the data of the data line 103c. The operation of the DAT0 switch circuit 108 sets the coupling relationship of the signal lines so that the status information of the 8-bit card module is returned to the card host I/F 102a as well as the card host I/F 102b, when the enable signal EN12 is asserted, i.e., when the enable signal EN12 indicates an 8-bit mode. This reliably continues the conjunction operation of the card module host I/Fs 102a and 102b.

The card host I/Fs 102a and 102b respectively include response determination circuits C102a and C102b, and DAT0 determination circuits D102a and D102b. The response determination circuits C102a and C102b determine the validity of responses CMDa_I and CMDb_I to transmitted commands CMDa_O and CMDb_O. The DAT0 determination circuits D102a and D102b determine CRC statuses and busy signals transmitted to bit 0 of input data DATa_I and DATb_I.

In an 8-bit mode, the card host I/F 102b may not use the response determination circuit C102b and the DAT0 determination circuit D102b, but use the determination results of the response determination circuit C102a and the DAT0 determination circuit D102a of the card host I/F 102a. At this time, the functions of the response determination circuit C102b and the DAT0 determination circuit D102b may be disabled. This also reduces response errors caused by lack of a response.

Operation of the configuration according to this embodiment will be described below. First, as shown in FIG. 1, operation will be described where SD cards 105a and 105b for 4 bits are inserted into the card slots S105a and S105b. At this time, an “8-bit enable state” is not set at the 8-bit enable register 12, and the enable signal EN12 is negated.

The main microcomputer 10 sets an “identification command” at the register R102a in the card host I/F 102a via the host I/F 11 and the bit rearrangement circuit 13 using a boot sequence. In response, the card host I/F 102a issues the “identification command” to the SD card 105a via the card bus 103. When a response is returned from the SD card 105a within a predetermined time period, the main microcomputer 10 determines that the SD card 105a is coupled. The main microcomputer 10 also determines that the SD card 105b is coupled by performing similar processing on the card host I/F 102b.

Then, similar to conventional art, the main microcomputer 10 independently controls the SD cards 105a and 105b via the card host I/Fs 102a and 120b while disabling the “8-bit enable state” of the 8-bit enable register 12.

At this time, in the configuration of FIG. 3 with respect to the SD card 105a, a clock CLKa, a command CMDa_O, and data DATa_O output from the card host I/F 102a pass through the bridge circuit 106, and are input to the SD card 105a via the clock line 103a, the command line 103b, and the data line 103c, respectively. A response and data output from the SD card 105a to the command line 103b and the data line 103c pass through the bridge circuit 106, and are input to the card host I/F 102a as a command CMDa_I and data DATa_I.

With respect to the SD card 105b, since the enable signal EN12 is negated, a clock CLKb and a command CMDb_O output from the card host I/F 102b are selected by the selectors 107a and 107b, and data DATb_O passes through the bridge circuit 106a. The clock CLKb, the command CMDb_O, and the data DATb_O are input to the SD card 105b via the clock line 104a, the command line 104b, and the data line 104c, respectively. The selector 107c selects a response RSPb_I output from the SD card 105b to the command line 104b, which is input to the card host I/F 102b as a response CMDb_I. The DAT0 switch circuit 108 selects bit 0 of the data output from the SD card 105b via the data line 104c. That is, 4-bit data DATb_I′ output from the data line 104c is input to the card host I/F 102b as data DATb_I.

Then, as shown in FIG. 2, operation will be described where an M_MC105c for 8 bits is inserted into the card slot S105a. In this case, an “8-bit enable state” is set at the 8-bit enable register 12, and the enable signal EN12 is asserted.

The main microcomputer 10 sets an “identification command” at the register R102a in the card host I/F 102a via the host I/F 11 and the bit rearrangement circuit 13 using a boot sequence. In response, the card host I/F 102a issues the “identification command” to an MMC 105c for 8 bits via the card bus 103. When no response is returned from the MMC 105c for 8 bits within a predetermined time period, the main microcomputer 10 determines that the MMC is coupled.

Next, the main microcomputer 10 sets the “8-bit enable state” at the 8-bit enable register 12 to check the bits of the MMC, thereby asserting the enable signal EN12.

The main microcomputer 10 sets a “bus width check command” at the register R102a inside the card host I/F 102a. At this time, since the enable signal EN12 is asserted, the bit rearrangement circuit 13 writes the same commands to the register R102a and R102b.

Then, the main microcomputer 10 sequentially sets 8-bit test patterns at the buffer B102a inside the card host I/F 102a. At this time as well, since the enable signal EN12 is asserted, the bit rearrangement circuit 13 write the test patterns with rearranged bits to the buffers B102a and B102b. As a result, the card host I/Fs 102a and 102b output the 8-bit test patterns to the MMC 105c for 8 bits. The card host I/Fs 102a and 102b determine the bit width depending on whether or not a specified response pattern is returned from the MMC 105c for 8 bits, and outputs the result to the main microcomputer 10.

When the bit width is determined as 8 bits, the main microcomputer 10 controls the MMC 105c for 8 bits using the card host I/Fs 102a and 102b with the 8-bit enable register 12 set in the “8-bit enable state,” i.e., with the enable signal EN12 asserted.

When an MMC for 4 bits is coupled, the main microcomputer 10 disables the “8-bit enable state” at the 8-bit enable register 12, and controls the MMC for 4 bits using only the card host I/F 102a in the subsequent processing, similar to the SD card 105a.

When the enable signal EN12 is asserted, in the configuration of FIG. 3, a clock CLKa, a command CMDa_O, and data DATa_O output from the card host I/F 102a pass through the bridge circuit 106, and are input to the MMC 105c for 8 bits via the clock line 103a, the command line 103b, and the data line 103c, respectively. Furthermore, data DATb_O output from the card host I/F 102b also passes through the bridge circuit 106, and is input to the MMC 105c for 8 bits via the data line 104c.

At this time, since the enable signal EN12 is asserted, the selector 107a selects “0,” and the selector 107b selects “1.” That is, the clock CLKb and the command CMDb_O from the card host I/F 102b do not pass through the bridge circuit 106.

A response output from the MMC 105c for 8 bits to the command line 103b passes through the bridge circuit 106, and is input to the card host I/F 102a as a response CMDa_I. Furthermore, the response is selected by the selector 107c and is input to the card host I/F 102b as a response CMDb_I.

Data output from the MMC 105c for 8 bits to the data line 103c passes through the bridge circuit 106 and is input to the card host I/F 102a as data DATa_I.

The DAT0 switch circuit 108 selects bit 0 of data DATa_I or bit 0 of data DATb_I′ in response to the command CMDb_O output from the card host I/F 102b; and inputs it to the card host I/F 102b as DATb _I together with bit [3:1] of data DATb_I′.

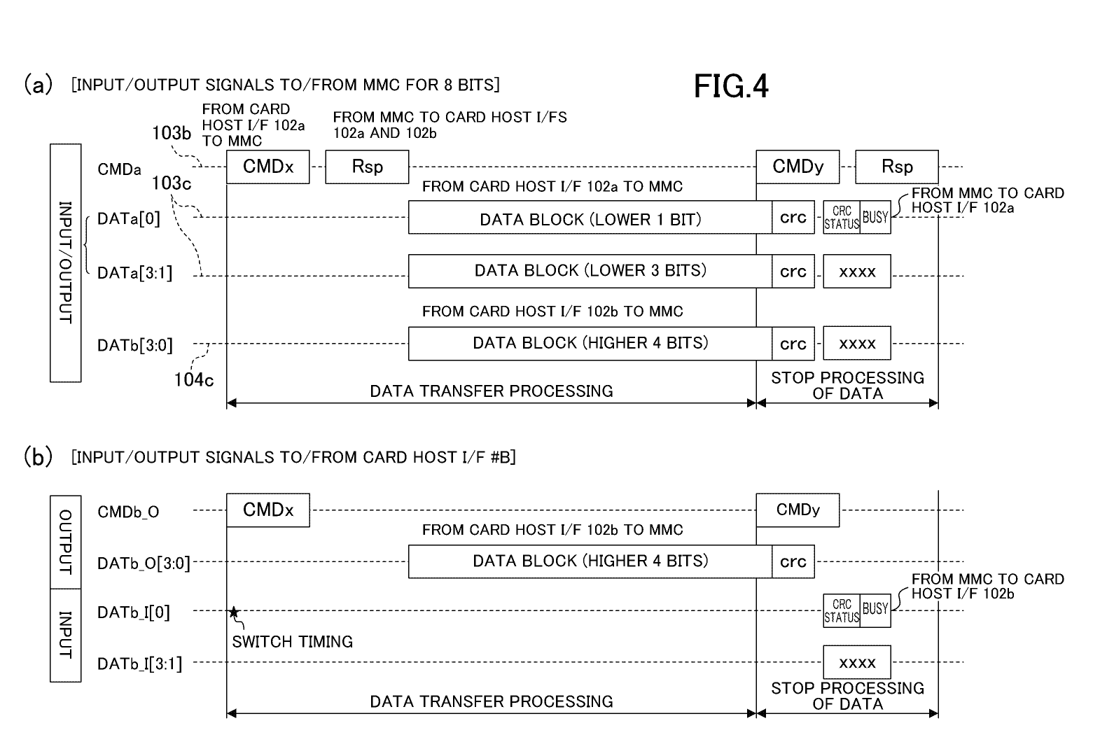

FIGS. 4A and 4B are timing charts in block writing where the MMC 105c for 8 bits is coupled. FIG. 4A is a timing chart of input and output signals to and from the MMC 105c for 8 bits. FIG. 4B is a timing chart of input and output signals to and from the card host I/F 102b.

As shown in FIG. 4A, a command “CMDx” is output from the command line 103b to the M_MC105c to execute data transfer processing. When the MMC105c receives the command “CMDx,” a response “Rsp” is input from the command line 103b to the card host I/Fs 102a and 102b. Then, data blocks to be written are sequentially output from the data lines 103c and 104c to the M_MC105c, and CRC is added at the ends of the data blocks on a bit line-by-bit line basis. At the transmission of the last data block, a command “CMDy” is output from the command line 103b to the M_MC105c to execute stop processing of the data.

Then, a “CRC status” of the received data and a “busy state” indicating in-processing are input from the MMC105c to DATa[0] of the data line. At the end, when the MMC105c receives a command transmitted earlier, a response “Rsp” is input from the command line 103b to the card host I/Fs 102a and 102b to end the block data writing. When the response “Rsp” is input, the card host I/F 102a outputs to the main microcomputer 10, an interrupt signal I102a indicating that there is a response.

As shown in FIG. 4B, output data DATb_O[3:0] to the card host I/F 102b passes through the bridge circuit 106, and is output to data DATb[3:0]. After outputting the CRC, the “CRC status” and the “busy state” input from the MMC105c only to data DATa[0] are also output to data DATb_I[0] by switching of the DAT0 switch circuit 108.

Note that the card host I/F 102b may not output the interrupt signal I102b by setting the main microcomputer 10 to mask an interrupt to a response. That is, in an 8-bit mode, the card host I/F 102b may be set to notify only an error interrupt to transmitted data among occurring interrupts. Alternately, in stead of providing the selector 107c, “no response” may be set at the register R102b of the card host I/F 102b to disable the function of the response determination circuit C102b itself.

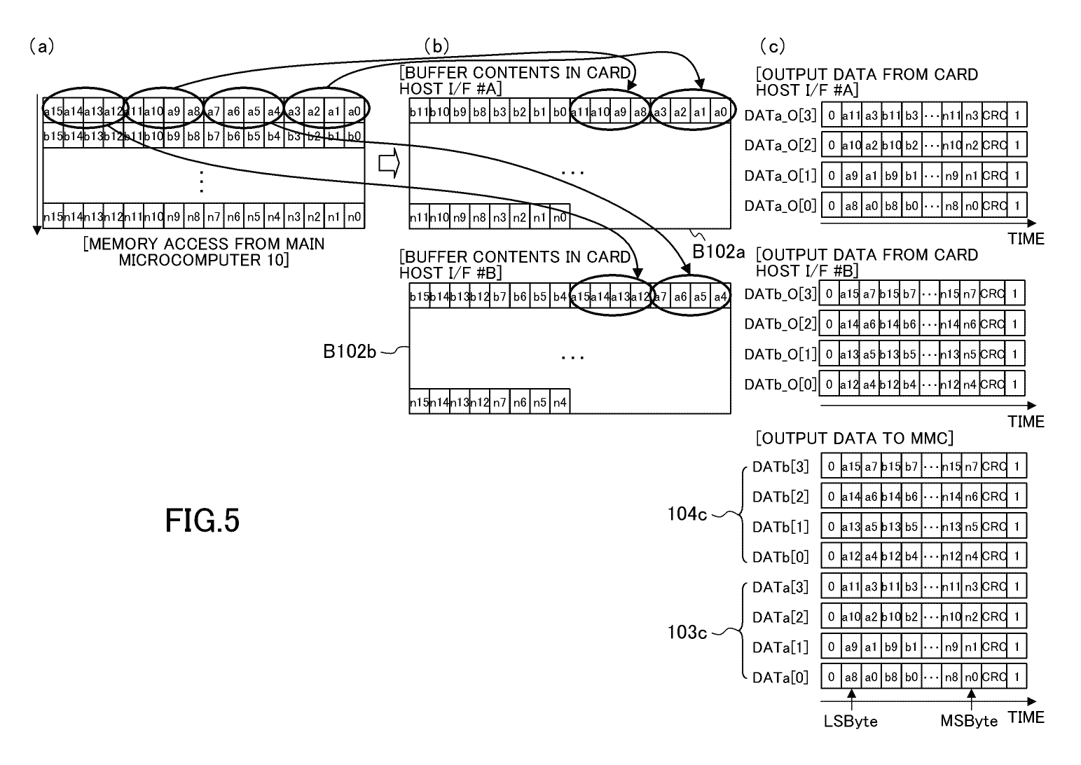

FIGS. 5A-5C illustrate bit rearrangement of the bit rearrangement circuit 13 where the MMC 105c for 8 bits is coupled.

As shown in FIG. 5A, when the main microcomputer 10 writes data of 16 bits a15-a0 to the MMC 105c for 8 bits, the main microcomputer 10 designates the address of the buffer B102a inside the card host I/F 102a, and transmits the data of 16 bits a15-a0 to the host I/F 11.

As shown in FIG. 5B, when such information is transmitted from the host I/Fs, the bit rearrangement circuit 13 writes 8 bits of all-a8 and a3-a0 out of the data of 16 bits a15-a0 to the buffer B102a, and 8 bits of a15-a12 and a7-a4 to the buffer B102b. Similar processing is repeated in accordance with the amount of data when continuously writing the data in, e.g., block writing.

Note that this embodiment employs byte access for writing 8 bits to each of the buffers B102a and 102b. Alternately, word access for storing 32 bits inside the host I/F 11 etc., and writing 16 bits to each of the buffers B102a and B102b may be used.

Once data is written to the buffers, the card host I/F 102a outputs a11-a8 out of the written data of the 8 bits a11-a8 and a3-a0 to data DATa_O[3]-DATa_O[0], and then outputs a3-a0 to data DATa_O[3]-DATa_O[0]. This process is repeated in accordance with the amount of data, and a CRC for each bit is added at the end. The card host I/F 102b outputs a15-a12 out of the written data of the 8 bits a15-a12 and a7-a3 to the data DATb_O[3]-DATb_O[0], and then outputs a7-a4 to data DATb_O[3]˜DATb_O[0]. This process is repeated in accordance with the amount of data, and a CRC for each bit is added at the end.

As a result, higher 8 bits are output from the data lines 103c and 104c in the order of data a15-a0 written by the main microcomputer 10. Note that the bit rearrangement described in this embodiment is merely an example, and other bit rearrangement such as dividing data by 2 bits may be used.

As described above, according to this embodiment, the plurality of card host I/Fs operate in a set in conjunction with each other to control a card module with a bit width different from a bit width of the individual card host I/Fs. This reduces redundant data lines, thereby reducing the number of the input and output terminals. Even when a plurality of card modules are coupled, an increase in the area can be mitigated and costs can be reduced.

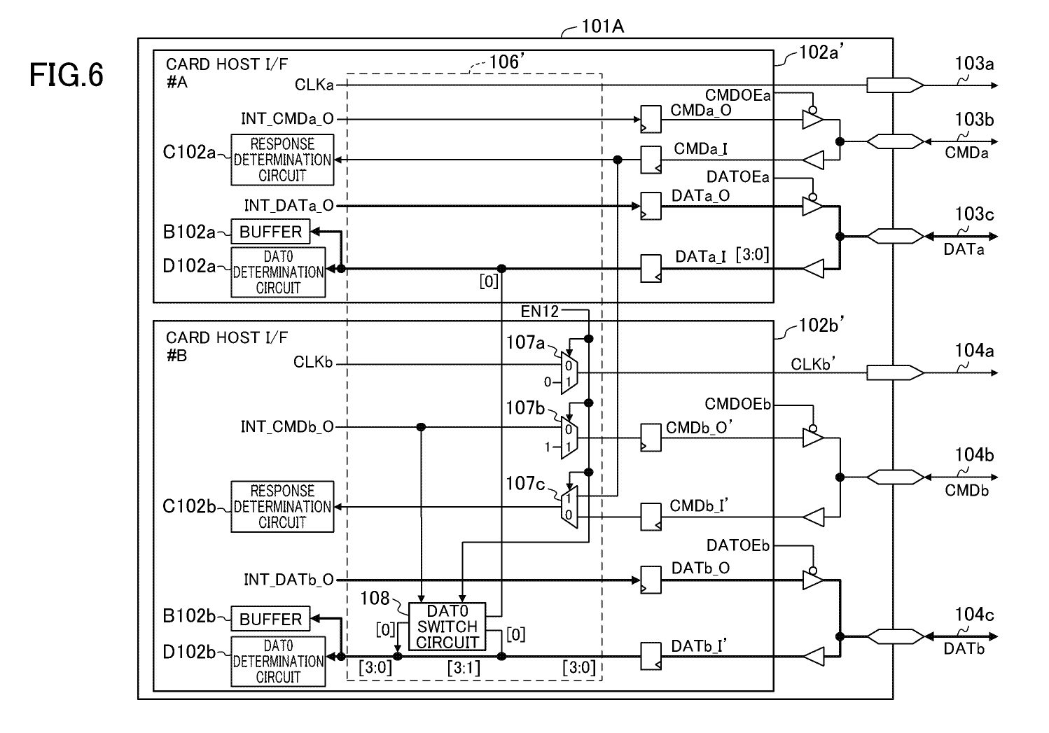

While in the above configuration, the bridge circuit 106 is provided separately from the card host I/Fs 102a and 102b, the bridge circuit 106′ may be included in the card host I/Fs 102a′ and 102b′ as in the card host LSI 101A shown in FIG. 6 as a variation. The elements shown in FIG. 6 similarly operate to those in the above-described configuration.

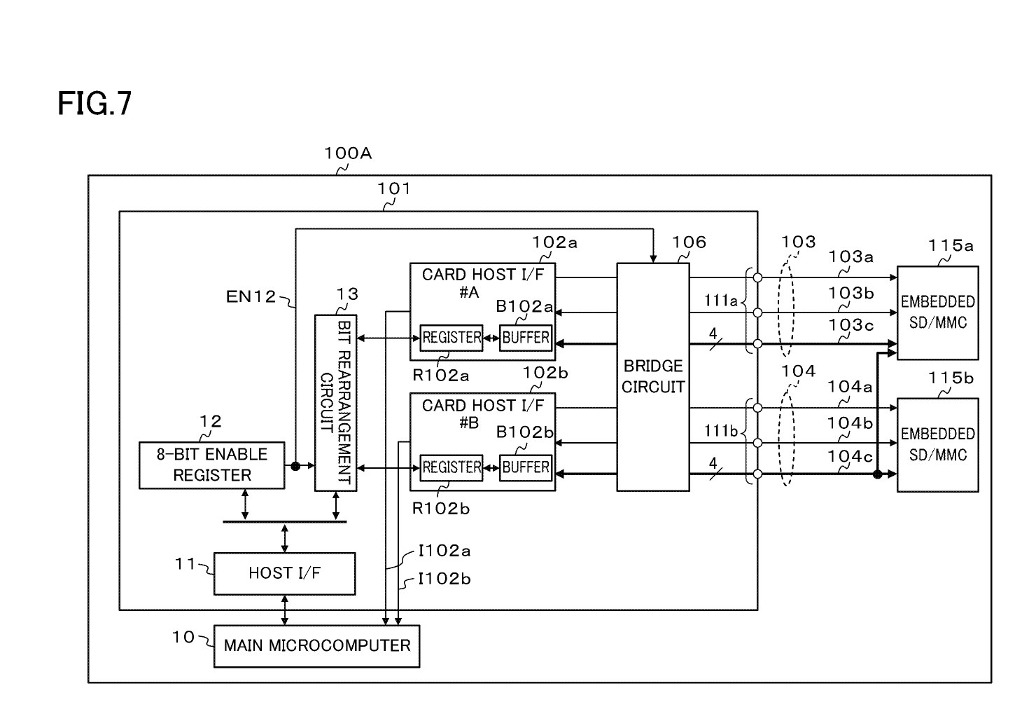

As shown in FIG. 7, the set device 100A may not include any card slot, and the card host LSI 101 may control embedded modules 115a and 115b. Also, the set device may include both of a card slot and an embedded module.

While in this embodiment, the lower 4 bits of the total 8 bits of data of the data lines 103c and 104c are processed by the card host I/F 102a and the higher 4 bits are processed by the card host I/F 102b, the present disclosure is not limited thereto. For example, the higher bits and the lower bits may be switched, or the 8 bits may be divided into 4 bits of odd numbers and even numbers. That is, preferable 4 bits may be selected from 8 bits and may be combined.

While in this embodiment, a 16-bit little endian is used as the width of data from the main microcomputer, the present disclosure is not limited thereto. In an 8-bit microcomputer, 16 bits or 32 bits may be stored inside a host I/F etc., and byte access or word access by 16 bits to the buffers B102a and 102b may be used, similar to this embodiment. In a 32-bit microcomputer, word access by 16 bits may be used.

While in this embodiment, the order of the bits are changed using the bit rearrangement circuit 13, the bit rearrangement circuit 13 may not be included. In this case, the main microcomputer 10 transmits data, of which the order of bits is changed, to the host I/F 11, thereby providing similar processing.

While in this embodiment, the MMC 105c for 8 bits can be inserted into the card slot S105a, the present disclosure is not limited thereto. The MMC 105c for 8 bits can be inserted into the card slot S105b. In this case, the selectors 107a, 107b, and 107c, and the DAT0 switch circuit 108 may be provided in the card host I/F 102a in the bridge circuit 106.

While in this embodiment, two card host I/Fs for 4-bit card modules control an 8-bit card module, the present disclosure is not limited thereto. For example, similar to this embodiment, the configuration can be achieved, in which two card host I/Fs for 8-bit card modules control a 16-bit card module. Alternately, similar to this embodiment, the configuration can be achieved, in which four card host I/Fs for 2-bit card modules control an 8-bit card module. That is, similar to this embodiment, the configuration can be achieved, in which M card host I/Fs, where M is an integer of 2 or more, for N-bit card modules, where N is an integer of 1 or more, control an (M×N)-bit card module.

### Second Embodiment

In a second embodiment, a set device including a card host LSI including a plurality of sets of the two card host I/Fs, the two card bus terminals, and the bridge circuit, which are shown in the first embodiment.

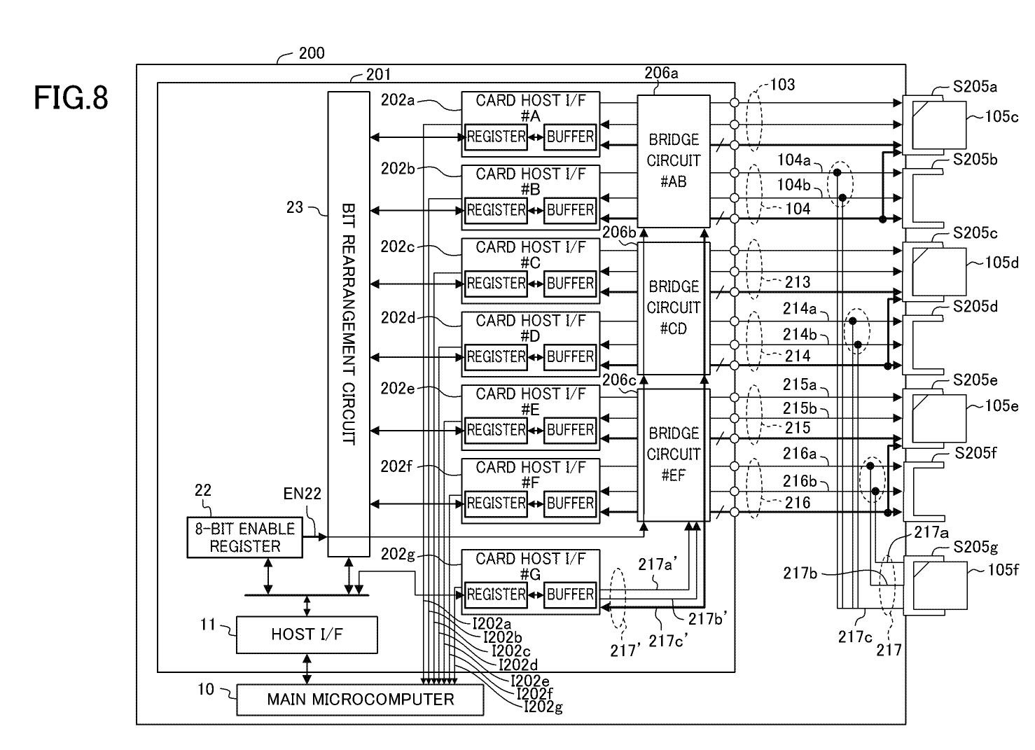

FIG. 8 illustrates a configuration of the set device according to the second embodiment. In FIG. 8, the same reference characters as those shown in FIG. 1 are used to represent equivalent elements. As shown in FIG. 8, a set device 200 includes a main microcomputer 10, a card host LSI 201, card busses 103, 104, 213, 214, 215, 216, and 217, and card slots S205a, S205b, S205c, S205d, S205e, S205f, and S205g. In FIG. 8, MMCs 105c, 105d, and 105e for 8 bits are inserted into card slot S205a, S205c, and S205e, respectively. A removable SD card 105f is inserted into a card slot S205g.

The card host LSI 201 includes card host I/Fs 202a (#A) and 202b (#B), a bridge circuit 206a (#AB), card host I/Fs 202c (#C) and 202d (#D), and a bridge circuit 206b (#CD), as well as card host I/Fs 202e (#E) and 202f (#F), and a bridge circuit 206c (#EF). These elements have similar configurations to those in the first embodiment. In addition, a card host I/F 202g (#G) is provided as a second card host I/F.

An 8-bit enable register 22 is the same as the 8-bit enable register 12 of FIG. 1, but 1 bit is expanded to 3 bits. A bit rearrangement circuit 23 is the same as the bit rearrangement circuit 13, but is expanded to accept the card host I/Fs 202a-202f. An enable signal EN22 expanded to 3 bits is transmitted from the 8-bit enable register 22 to the bit rearrangement circuit 23. Bits 0, 1, and 2 of the enable signal EN22 are transmitted to the bridge circuits 206a, 206b, and 206c, respectively.

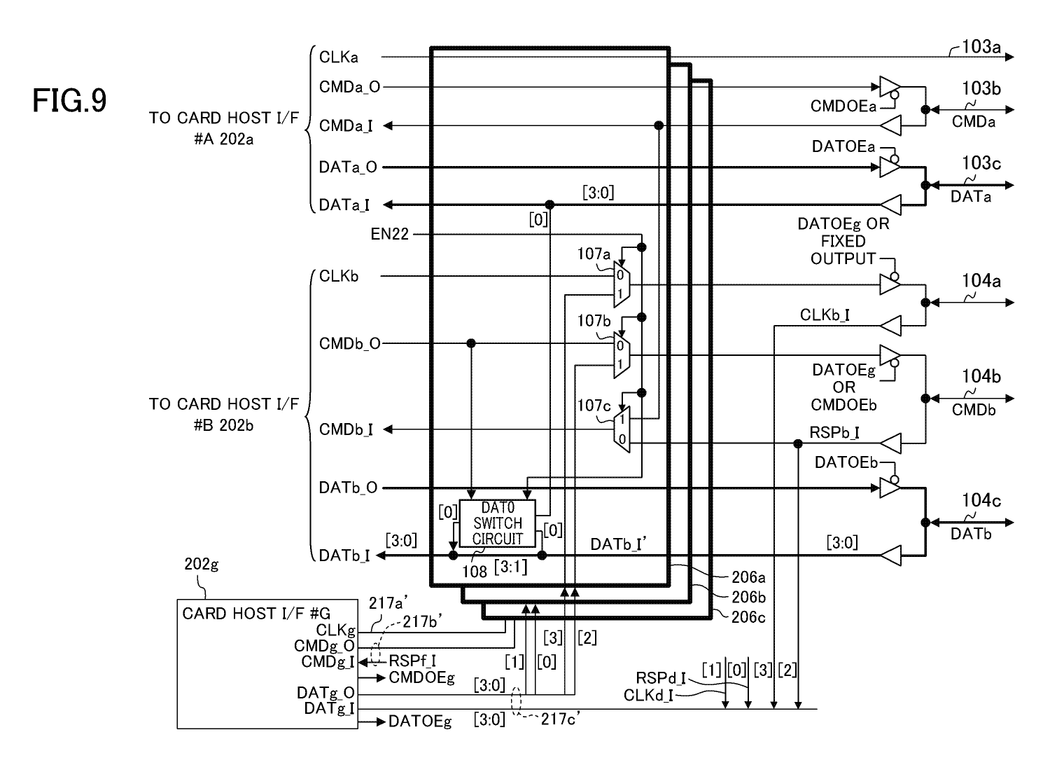

FIG. 9 illustrates a detailed configuration of the bridge circuits 206a, 206b, and 206c, and a card host I/F 202g and its surroundings. Note that FIG. 9 shows the inner configuration of the bridge circuit 206a only. The inner configurations of the bridge circuits 206b and 206c are similar to that of the bridge circuit 206a, and are omitted.

The bridge circuit 206a has a similar configuration to the bridge circuit 106 shown in FIG. 3. However, inputs to the selectors 107a and 107b when the enable signal EN22 is asserted are output from the card host I/F 202g. That is, the selectors 107a and 107b select the clock CLKb and the command CMDb_O output from the card host I/F 202b when the enable signal EN22 is negated, and a signal output from the card host I/F 202g when the enable signal EN22 is asserted.

The card host I/F 202g includes a clock line 217a′ (CLKg), a command line 217b′ (CMDg_O and CMDg_I) and a 4-bit data line 217c′ (DATg_O and DATg_I) as input and output signal lines. The clock line 104a is dedicated for output in FIG. 3, but is a bidirectional signal line in FIG. 9.

The input and output signal lines of the card host I/F 202g are coupled to the bridge circuits 206a, 206b, and 206c, etc. as follows. At the output (DATg_O) of the 4-bit data line 217c′, bits 3 and 2 are coupled to the selectors 107a and 107b of the bridge circuit 206a, and bits 1 and 0 are coupled to the selectors 107a and 107b of the bridge circuit 206b. On the other hand, at the input (DATg_I) of the 4-bit data line 217c′, bits 3 and 2 are coupled to the clock line 104a (CLKb_I) and the command line 104b (RSPb I), and bits 1 and 0 are coupled to a clock line 214a (CLKd_I) and a command line 214b (RSPd_I). Furthermore, the clock line 217a′ (CLKg) is coupled to the selector 107a inside the bridge circuit 206c. The output (CMDg_O) of the command line 217b′ is coupled to the selector 107b of the bridge circuit 206c, and the input (CMDg_I) is coupled to the input (RSPf_I) of the command line 216b.

This configuration allows the card host I/F 202g to control the SD card 105f inserted into the card slot S205g via unused ones of the card bus terminals (the card bus terminals coupled to the clock lines 104a, 214a, and 216a, and the command lines 104b, 214b, and 216b) in an 8-bit mode. Specifically, when the MMCs 105c, 105d, and 105e for 8 bits are coupled, i.e., when all of the 3 bits of the enable signal EN22 are asserted, the unused clock lines 104a, 214a, and 216a, and the command lines 104b, 214b, and 216b are allocated to the clock line 217a, the command line 217b, and the 4-bit data line 217c for controlling the SD card 105f, thereby forming a new card bus 217.

Note that, the switch between the outputs and inputs of the clock line 104a and the command line 104b are controlled with a fixed output and an output signal CMODEb of a card bus I/F202b when the card bus 217 is not used, and with an output signal DATOEg of the card host I/F 202g when the card bus 217 is used. The switch between the outputs and inputs of the clock lines 214a and 216a, and the command lines 214b and 216b are similarly controlled.

As described above, according to this embodiment, another card module can be controlled via the unused ones of the card bus terminals in an 8-bit mode. This increases the number of the card slots of the set device without increasing the number of the input and output terminals of the card host LSI.

### Third Embodiment

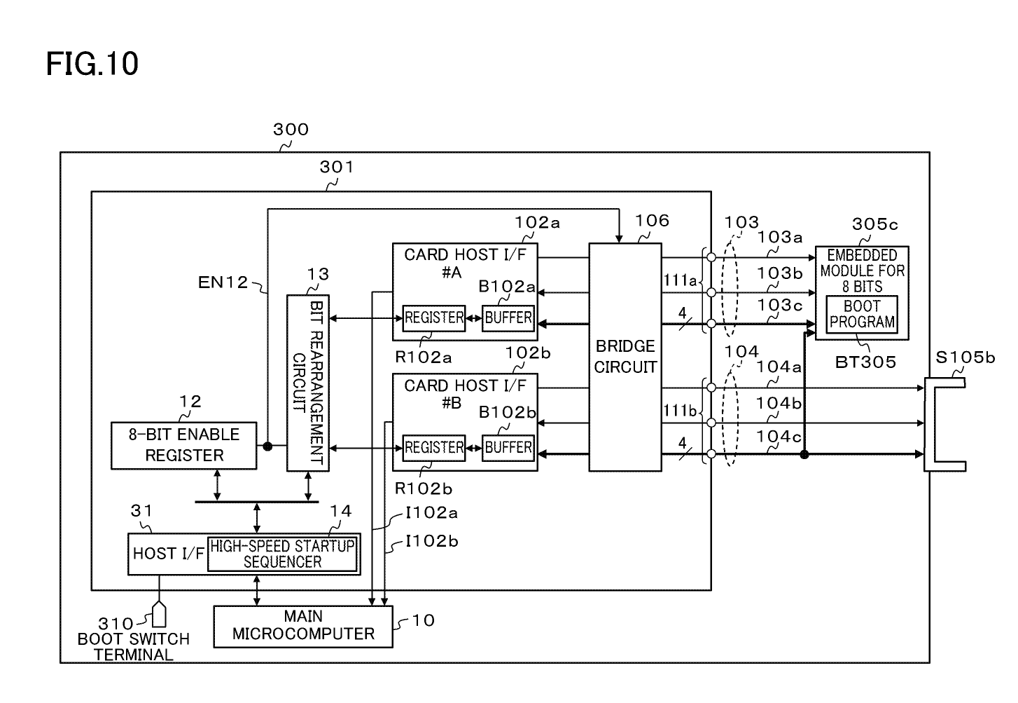

FIG. 10 illustrates a configuration of a set device according to a third embodiment. In FIG. 10, the same reference characters as those shown in FIG. 1 are used to represent equivalent elements, and the explanation thereof will be omitted.

As shown in FIG. 10, a set device 300 includes a main microcomputer 10, a card host LSI 301, card busses 103 and 104, an embedded MMC 305c for 8 bits, and a card slot S105b. That is, the card host LSI 301 controls the embedded MMC 305c via the card bus 103. The card host LSI 301 differs from the card host LSI 101 in that a host I/F 31 includes a high-speed startup sequencer 14, and that a boot switch terminal 310 is included. The high-speed startup sequencer 14 starts in turning on the card host LSI 301, when the boot switch terminal 310 is activated.

A boot program BT305 of the main microcomputer 10 is stored in the embedded MMC 305c for 8 bits. At the start-up of the set device 300, the main microcomputer 10 reads and executes the boot program BT305 from the embedded MMC 305c for 8 bits. Note that, similar to the first embodiment, the main microcomputer 10 controls the entire card host LSI 301 via the host I/F 31 at a stationary state.

Operation of the high-speed startup sequencer 14 will be described below.

When the boot switch terminal 310 is activated at the start-up of the set device 300, i. e., in turning on the card host LSI 301, the high-speed startup sequencer 14 inside the host I/F 31 starts and operates instead of the main microcomputer 10. First, the high-speed startup sequencer 14 issues a command and makes the following determination.
Determination of the type of the card coupled to the card bus 103
Determination whether or not the card coupled to the card bus 103 is bootable

When the card coupled to the card bus 103, i.e., the embedded MMC 305c for 8 bits is determined as bootable, the high-speed startup sequencer 14 controls the register R102a and the buffer B102a of the card host I/F 102a to store boot data into the buffer B102a inside the card host I/F 102a. After that, the high-speed startup sequencer 14 issues a card initialization command, and sets an “8-bit enable state” at the 8-bit enable register 12 to determine whether or not the embedded MMC 305c is for 8 bits. If not, the high-speed startup sequencer 14 disables the “8-bit enable state” at the 8-bit enable register 12 to operate in a 4-bit mode. That is, the high-speed startup sequencer 14 determines whether or not the 8-bit card module is coupled to the card host LSI 301, and sets the enable signal EN12 stored in the enable register 12 to indicate an 8-bit mode, when the 8-bit card module is coupled.

As such, the high-speed startup sequencer 14 is included in the card host LSI 301, thereby enabling not only automatic read-out of the boot program BT305 but also initialization of a card and determination of a data bit width using only the card host LSI 301. This reduces the load of the main microcomputer 10, and allows high-speed start-up of the embedded MMC 305c for 8 bits.

Note that, when the boot switch terminal 310 is deactivated when turning on power supply, the high-speed startup sequencer 14 does not operate and operation similar to that in the first embodiment is performed. The embedded MMC 305c for 8 bits is treated as a normal MMC. That is, the main microcomputer 10 controls initialization of the embedded MMC 305c for 8 bits, an “8-bit enable state” at the 8-bit enable register 12, etc.

While the high-speed startup sequencer 14 issues a command and determines the type and bootability of the card, the present disclosure is not limited thereto. For example, determination by issuance of a command becomes unnecessary by separately providing a terminal for setting the type and bootability, thereby allowing start-up at higher speed. While whether or not the card is for 8 bits is determined after storing boot data in the buffer B102a, the present disclosure is not limited thereto. For example, by providing a terminal for determining whether or not the card is for 8 bits, boot data can be also stored in an 8-bit mode when the card is for 8-bits, thereby allowing start-up at higher speed.

As described above, according to this embodiment, the high-speed startup sequencer 14 provided inside the host I/F 31 controls the 8-bit enable register 12. This provides the advantage of reducing the load of the main microcomputer 10 in addition to the advantages of the first embodiment. By controlling with hardware, start-up can be at high-speed, and it becomes unnecessary to start the main microcomputer 10 in advance, thereby reducing power consumption.

Note that, even when an 8-bit card module is coupled to the card host LSI 301, the high-speed startup sequencer 14 preferably sets the enable signal EN12 stored in the enable register 12 not to indicate an 8-bit mode, when another card module is also coupled to the card host LSI 301.

This is also applicable to the case where a main microcomputer determines whether or not a card host LSI is in an 8-bit mode. That is, even when an 8-bit card module is coupled to the card host LSI, the main microcomputer does not preferably set the card host LSI to an 8-bit mode when another card module is also coupled to the card host LSI.

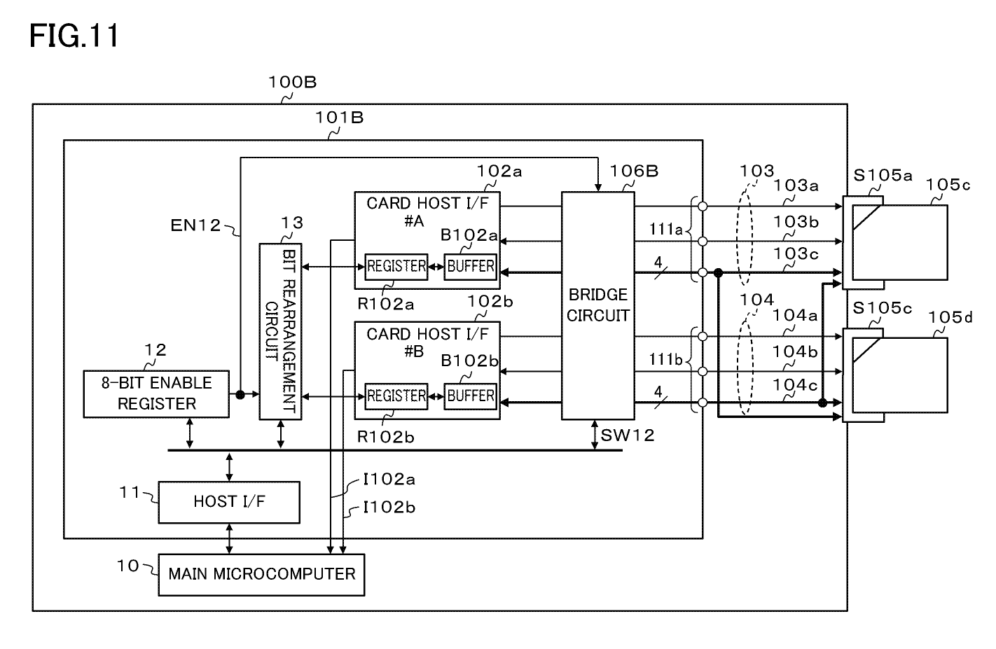

While in the above-described embodiments, either one of two card busses coupled to the bridge circuit can be coupled to the card module for 8 bits. On the other hand, as in the set device 100B shown in FIG. 11, the configuration can be achieved, in which both of two card busses 103 and 104 coupled to a bridge circuit 106B of a card host LSI 101B can be coupled to card modules for 8 bits.

In the configuration of FIG. 11, a 4-bit data line 103c is coupled to a card slot S105b, and MMCs 105c and 105d for 8 bits are inserted into card slots S105a and S105b. The bridge circuit 106B includes the selectors 107a, 107b, and 107c, and the DAT0 switch circuit 108, which are shown in FIG. 3, not only at a card host I/F 102b but also at a card host I/F 102a. A host I/F 11 provides the bridge circuit 106B with a switch signal SW12 indicating into which of the card slots S105a and S105b the MMC for 8 bits is inserted.

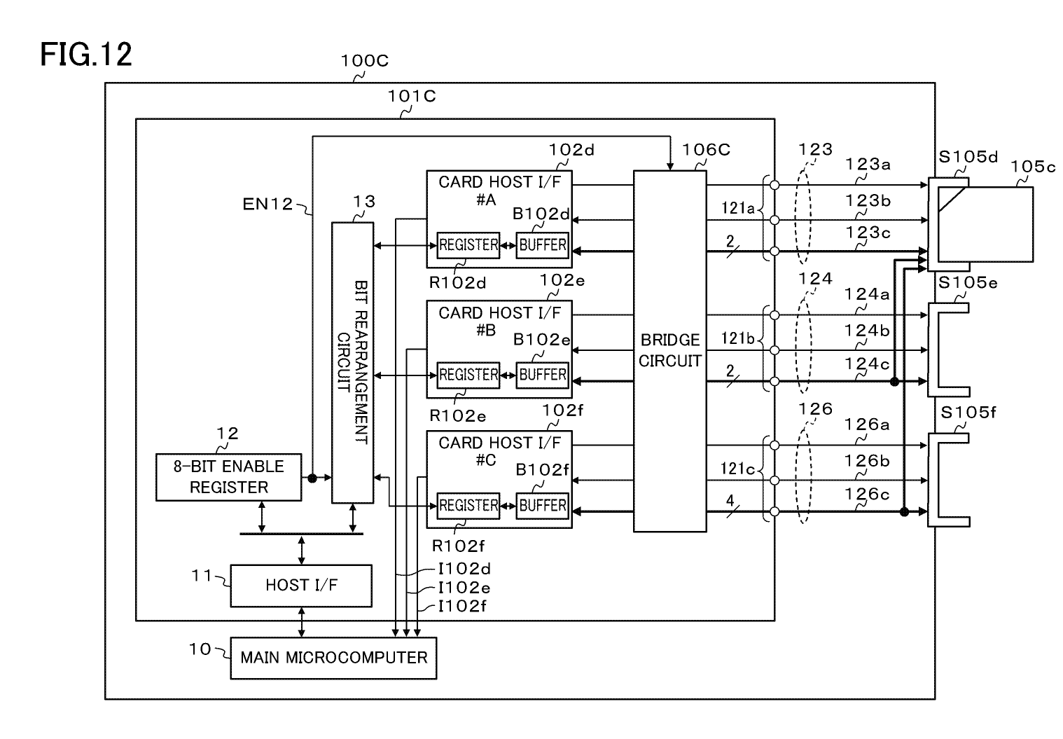

FIG. 12 illustrates a configuration for controlling a card module for 8 bits using three card host I/Fs. In a set device 100C shown in FIG. 12, a card host LSI 101C includes a bridge circuit 106C between three card host I/Fs 102d, 102e, and 102f, and three card bus terminals 121a, 121b, and 121c. The card bus terminals 121a, 121b, and 121c are coupled to card slots S105d, S105e, and S105f via card busses 123, 124, and 126, respectively. Data lines 124c and 126c are also coupled to the card slot S105d. That is, an 8-bit data line including the combination of 2-bit data lines 123c and 124c and a 4-bit data line 126c controls an MMC 105c for 8 bits. The bridge circuit 106C includes the selectors 107a, 107b, and 107c and the DAT0 switch circuit 108, which are shown in FIG. 3, at each of the card host I/F 102e and the card host I/F 102f.

While in the above embodiments, examples have been described where all data lines of a card bus are used for controlling another card module, some of the data lines of the card bus may be used for controlling another card module. For example, in the configuration of FIG. 1, the data line 104c of the card bus 104 has in total 8 bits, in which 4 bits may be coupled to the card slot S105a.

As can be seen from the above explanation, the above-described embodiments can be easily expanded to the following configurations. Specifically, the card host LSI includes M card host I/Fs, where M is an integer of two or more, for Ni-bit card modules, where i ranges from 1 to M and Ni is an integer of 1 or more; M card bus terminals; and a bridge circuit setting coupling relationship of signal lines between the M card host I/Fs and the M card bus terminals. The bridge circuit receives an enable signal indicating whether or not the card host LSI is in an L-bit mode, where L is an integer of two or more, for controlling an L-bit card module with a plurality of card host I/Fs. The bridge circuit sets the coupling relationship of the signal lines between the M card host I/Fs and the M card bus terminals so that a card host I/F corresponding to a card bus coupled to the L-bit card module and the other card host I/F(s) operate in conjunction with each other to control the L-bit card module, when the enable signal indicates the L-bit mode.

### Fourth Embodiment

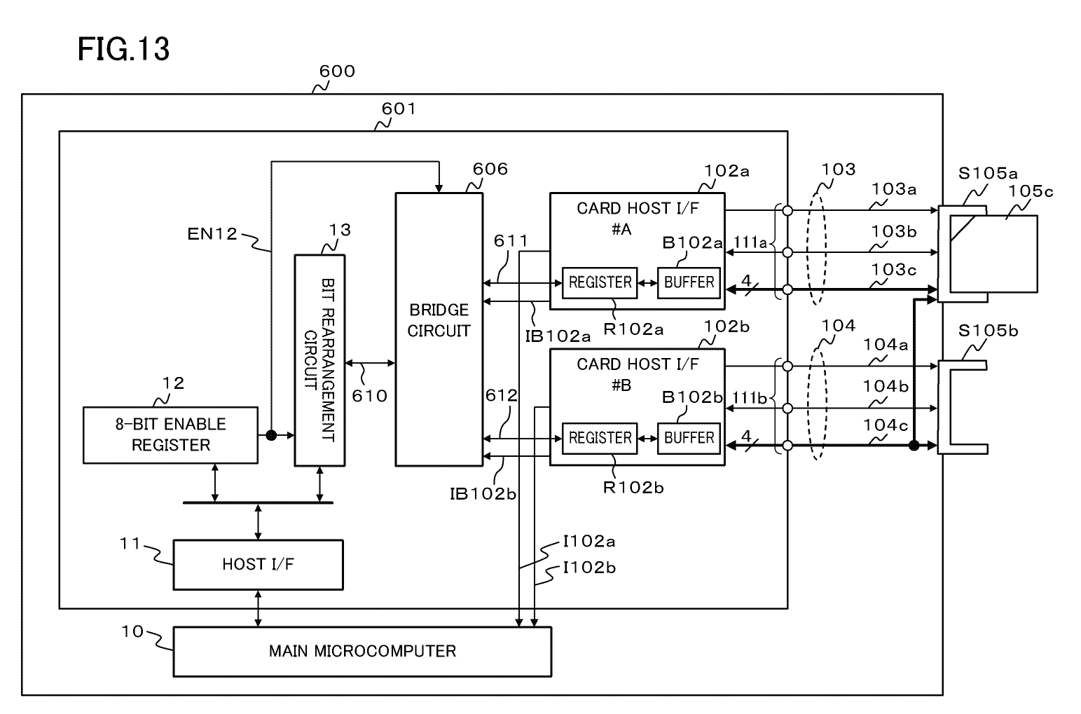

FIG. 13 illustrates a configuration of a set device according to a fourth embodiment. In FIG. 13, the same reference characters as those shown in FIG. 1 are used to represent equivalent elements, and the explanation thereof will be omitted.

As shown in FIG. 13, a set device 600 includes a main microcomputer 10, a card host LSI 601, card busses 103 and 104, and card slots S105a and S105b. Similar to the card host LSI 101 of FIG. 1, the card host LSI 601 has the function of controlling a plurality of card modules. The card host LSI 601 also accepts 8-bit card modules. FIG. 13 illustrates that an MMC 105c for 8 bits is inserted into the card slot S105a of the set device 600.

The card host LSI 601 differs from the card host LSI 101 in that a bridge circuit 606 is located between card host I/Fs 102a and 102b, and a bit rearrangement circuit 13. The bridge circuit 606 is coupled to the bit rearrangement circuit 13 by a card host bus 610, coupled to the card host I/F 102a by an #A access bus 611, and coupled to the card host I/F 102b by a #B access bus 612. The card host I/Fs 102a and 102b respectively output interrupt signals IB102a and IB102b in a non-busy state to the bridge circuit 606. An “interrupt signal in a non-busy state” is an interrupt asserted when a busy status transmitted after transfer of write data is in a “non-busy state” at issuance of a write command.

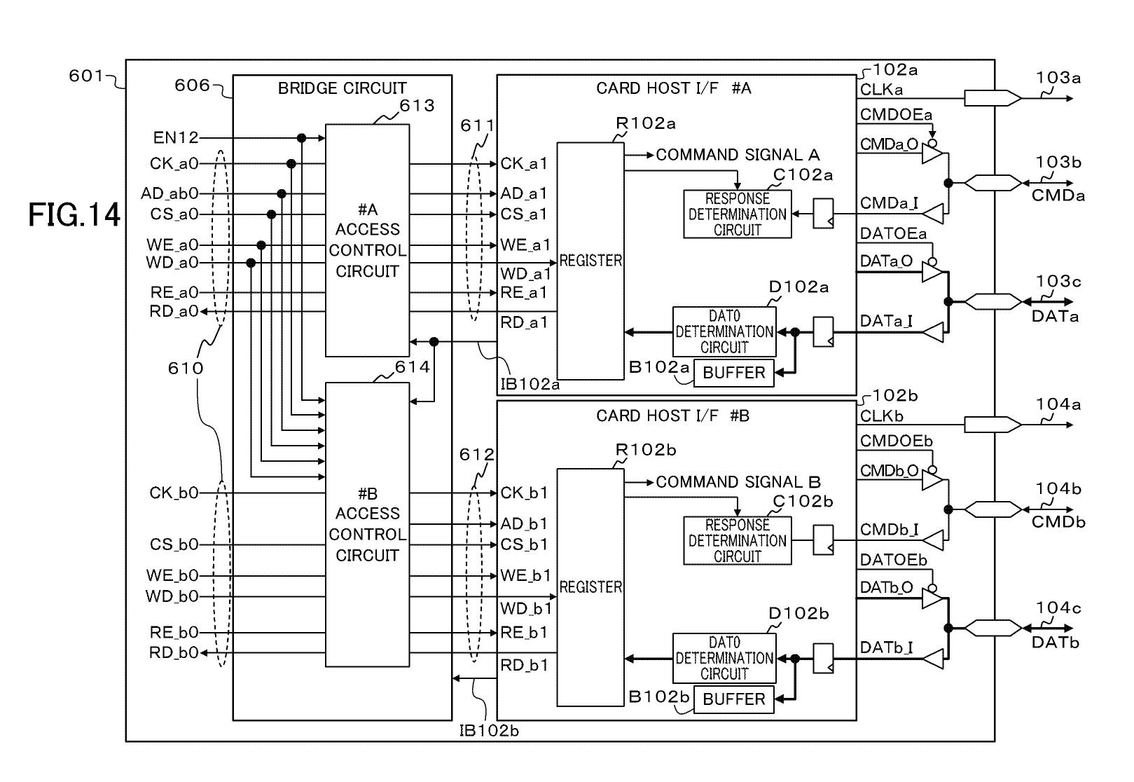

FIG. 14 illustrates a detailed configuration of the bridge circuit 606 and its surroundings. As shown in FIG. 14, the bridge circuit 606 includes a #A access control circuit 613, and a #B access control circuit 614. The bridge circuit 606 provides the card host I/Fs 102a and 102b with a control signal received from outside the card host LSI 601 via a host I/F 11, and controls the card host I/Fs 102a and 102b.

The card host bus 610 includes signal lines for transmitting clock signals CK_a0 and CK_b0, an address signal AD_ab0, chip enable signals CS_a0 and CS_b0, write enable signals WE_a0 and WE_b0, write data signals WD_a0 and WD_b0, read enable signals RE_a0 and RE_b0, and read data signals RD_a0 and RD_b0. These signals are input to the #A access control circuit 613 and/or the #B access control circuit 614.

The #A access bus 611 includes signal lines for transmitting a clock signal CK_a1, an address signal AD_a1, a chip enable signal CS_a1, a write enable signal WE_a1, a write data signal WD_a1, and a read enable signal RE_a1, which are output from the #A access control circuit 613; and a read data signal RD_a1 output from the card host I/F 102a. The #B access bus 612 includes signal lines for transmitting a clock signal CK_b1, an address signal AD_b1, a chip enable signal CS_b1, a write enable signal WE_b1, a write data signal WD_b1, and a read enable signal RE_b1, which are output from the #B access control circuit 614; and a read data signal RD_b1 output from the card host I/F 102b.

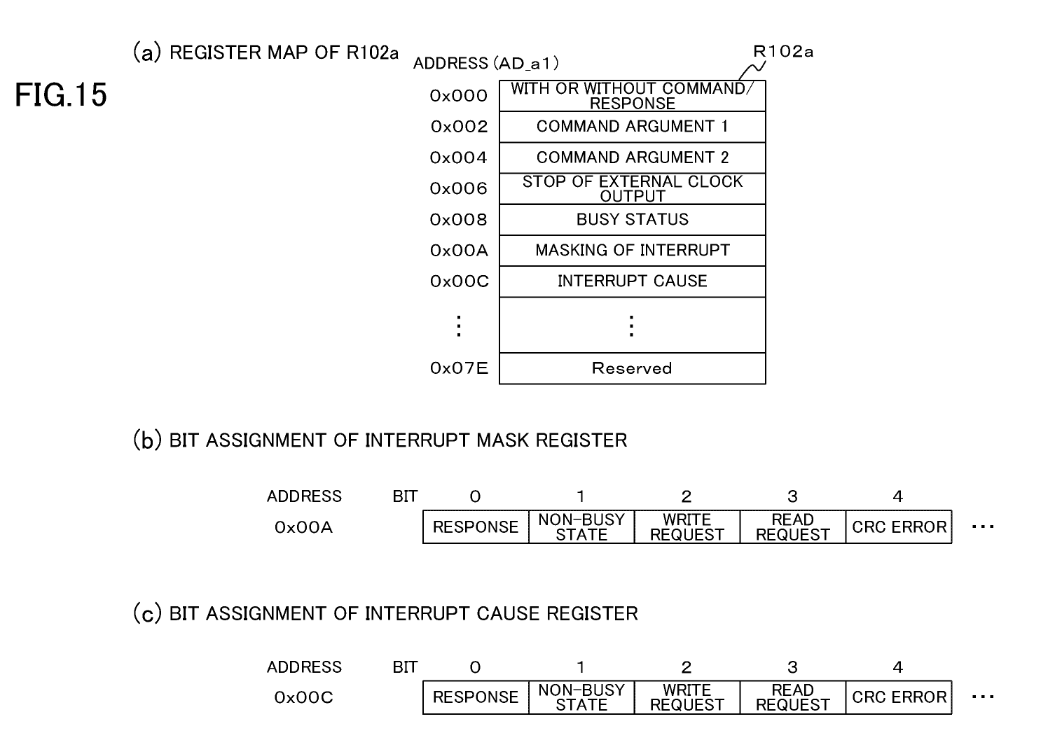

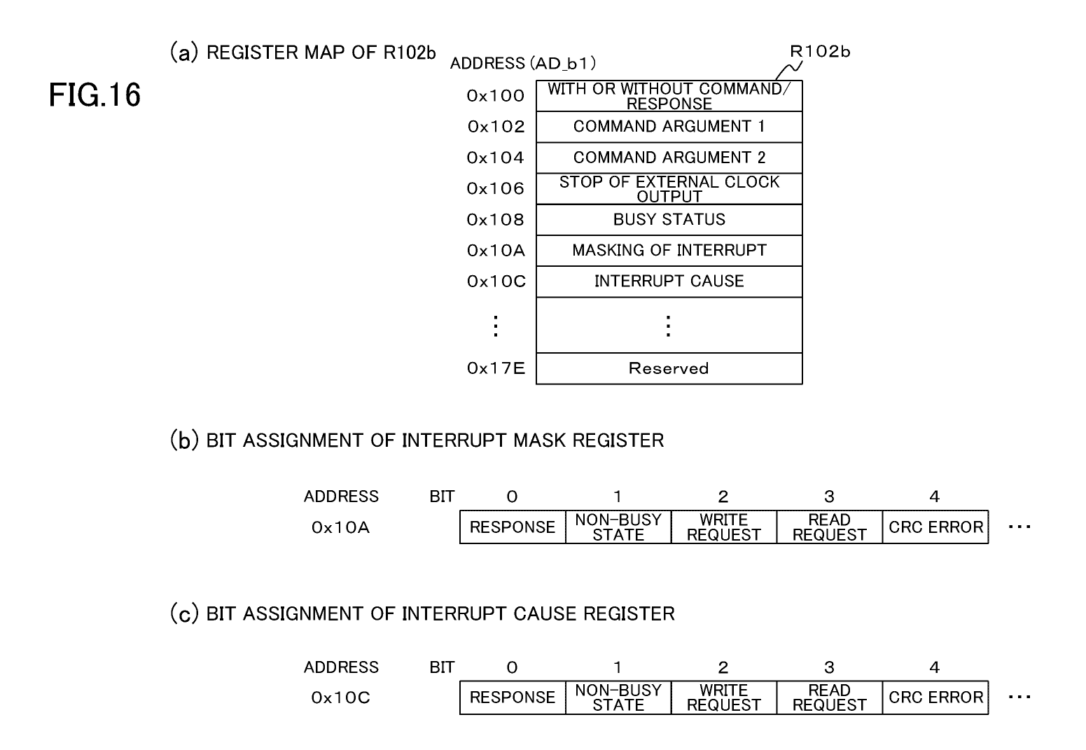

FIGS. 15A-C and 16A-C respectively illustrate example configurations of the registers R102a and R102b included in the card host I/Fs 102a and 102b. FIGS. 15A and 16A are register maps, which are the same in the registers R102a and R102b except for the addresses. FIGS. 15B and 16B illustrate bit assignment of interrupt mask registers. The interrupt mask registers have the function of setting an interrupt to be masked according to the cause so that the interrupt is not asserted at the occurrence. An address 0x00A is the interrupt mask register at the register R102a, and an address 0x10A is the interrupt mask register at the register R102b. Masking of a response interrupt is assigned to bit 0, masking of an interrupt in a non-busy state is assigned to bit 1, masking of a write request interrupt is assigned to bit 2, masking for a read request interrupt is assigned to bit 3, and masking of a CRC error interrupt is assigned to bit 4. FIGS. 15C and 16C illustrate bit assignment of interrupt cause registers. The interrupt cause registers have the function of displaying the cause of an interrupt when the interrupt is asserted. An address 0x00C is the interrupt cause register at the register R102a, and an address 0x10C is the interrupt cause register at the register R102b. A response interrupt is assigned to bit 0, an interrupt in a non-busy state is assigned to bit 1, a write request interrupt is assigned to bit 2, and a read request interrupt is assigned to bit 3, and a CRC error interrupt is assigned to bit 4.

Operation of the configuration according to this embodiment will be described below.

When the enable signal EN12 is negated, the #A access control circuit 613 and the #B access control circuit 614 allow the signals to pass. That is, the signals CK_a0, AD_ab0, CS_a0, WE_a0, WD_a0, and RE_a0 input via the card host bus 610 pass through the #A access control circuit 613, and are output to the card host I/F 102a as the signals CK_a1, AD_a1, CS_a1, WE_a1, WD_a1, and RE_a1, respectively. The signal RD_a1 output from the card host I/F 102a passes through the #A access control circuit 613, and is output to the card host bus 610 as the signal RD_a0. Similarly, the signals CK_b0, AD_ab0, CS_b0, WE_b0, WD_b0, and RE_b0 input via the card host bus 610 pass through the #B access control circuit 614, and are output to the card host I/F 102b as the signals CK_b1, AD_b1, CS_b1, WE_b1, WD_b1, and RE_b1. The signal RD_b1 output from the card host 102b passes through the #B access control circuit 614, and is output to the card host bus 610 as the signal RD_b0.

When negation of the enable signal EN12 begins, the bridge circuit 606 sets bit 1 of the interrupt mask registers (the address 0x00A of the register R102a and the address 0x10A of the register R102b) of the card host I/Fs 102a and 102b to the “masking of an interrupt in a non-busy state.” Due to the control, interrupt signals IB 102a and IB 102b in a non-busy state output from the card host I/Fs 102a and 102b are not asserted while the enable signal EN12 is negated.

When the enable signal EN12 is asserted, the #B access control circuit 614 outputs as the clock signal CK_b1, the clock signal CK_a0 which is the same as the clock signal CK_a1. Due to this feature, the card host I/Fs 102a and 102b operate in synchronization with the clock signal CK_a0. That is, input and output data DATa_I and DATa_O to and from the card bus 103, and input and output data DATb_I and DATb_O to and from the card bus 104 are input and output in synchronization with the same clock signal CLKa.

When the #A access control circuit 613 sets a command and command arguments 1 and 2 at addresses 0x000, 0x002, and 0x004 of the register R102a, respectively, the #B access control circuit 614 converts input signals and output the signals to the #B access bus 612 to set the same contents at addresses 0x100, 0x102, and 0x104 at the register R102b.

When accessing the other addresses of the register R102a or accessing the register R102b, the signals of the card host bus 610 and the signals from the card host I/Fs 102a and 102b pass through the #A access control circuit 613 or the #B access control circuit 614, except for the clock signal CK_b1, similar to the case where the enable signal EN12 is negated.

The #B access control circuit 614 sets “stop of external clock output” at an address 0x106 of the register R102b. Then, no clock is output from the card host I/F 102b, and the output of the clock signal CLKb is stopped. The #B access control circuit 614 sets “no response” at an address 0x100 of the register R102b. Then, the function of the response determination circuit C102b is disabled at the card host I/F 102b, and the card host I/F 102b normally operates even when the response CMDb_I is not returned. Note that, this control of the register may be performed by the #B access control circuit 614 generating signals for the control or by the main microcomputer 10.

When a write command is issued at the MMC 105c for 8 bits, the busy status as status information of a card, which is transmitted only to the data DATa_I[0] after transfer of write data, needs to be controlled.

When assertion of the enable signal EN12 begins, the #A access control circuit 613 sets “unmasking of an interrupt in a non-busy state” at bit 1 of the address 0x00A of the register R102a. Then, the interrupt signal IB 102a in a non-busy state can be asserted from the card host I/F 102a. The busy statuses of the address 0x008 of the register R102a and the address 0x108 of the register R102b are set to “busy states” by default.

When the status information is input to the DAT0 determination circuit D102a via the data DATa_I[0] after the transfer of the write data, a “CRC status” and a “busy” status are determined. Only in a non-busy state, the “non-busy state” is written to the address 0x008 of the register R102a, and “interrupt in a non-busy state” is written to bit 1 of the address 0x00C. Accordingly, the interrupt signal IB 102a in a non-busy state to the bridge circuit 606 is asserted.

When the interrupt signal IB 102a in a non-busy state is asserted, the #A access control circuit 613 clears the “interrupt in a non-busy state” at bit 1 of the address 0x00C of the register R102a, and the #B access control circuit 614 sets the “non-busy state” at the address 0x108 of the register R102b.

As a result, the card host I/Fs 102a and 102b are both in “non-busy states” and in “no interrupt cause.” After resetting the busy statuses at the address 0x008 of the register R102a and the address 0x108 of the register R102b to “busy states,” the card host I/Fs 102a and 102b continue processing.

The card host I/F 102b may be set to notify all of the interrupt I102b. Alternately, the card host I/F 102b may be set to notify only an error interrupt of transmitted data among occurring interrupts. This control of the register may be performed by the #B access control circuit 614 generating signals for the control or by the main microcomputer 10.

Next, example configurations of the #A access control circuit 613 and the #B access control circuit 614 in the bridge circuit 606 will be described.

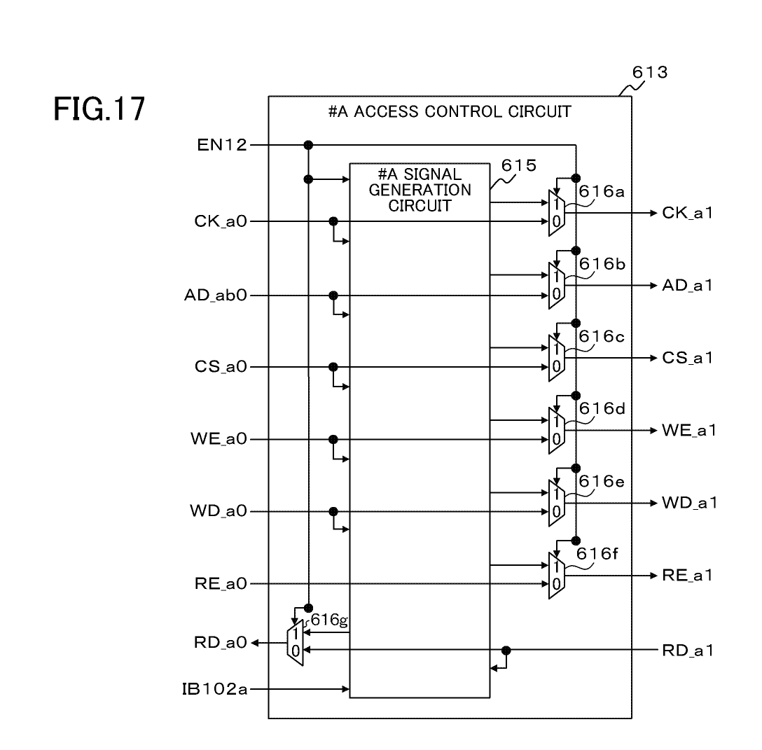

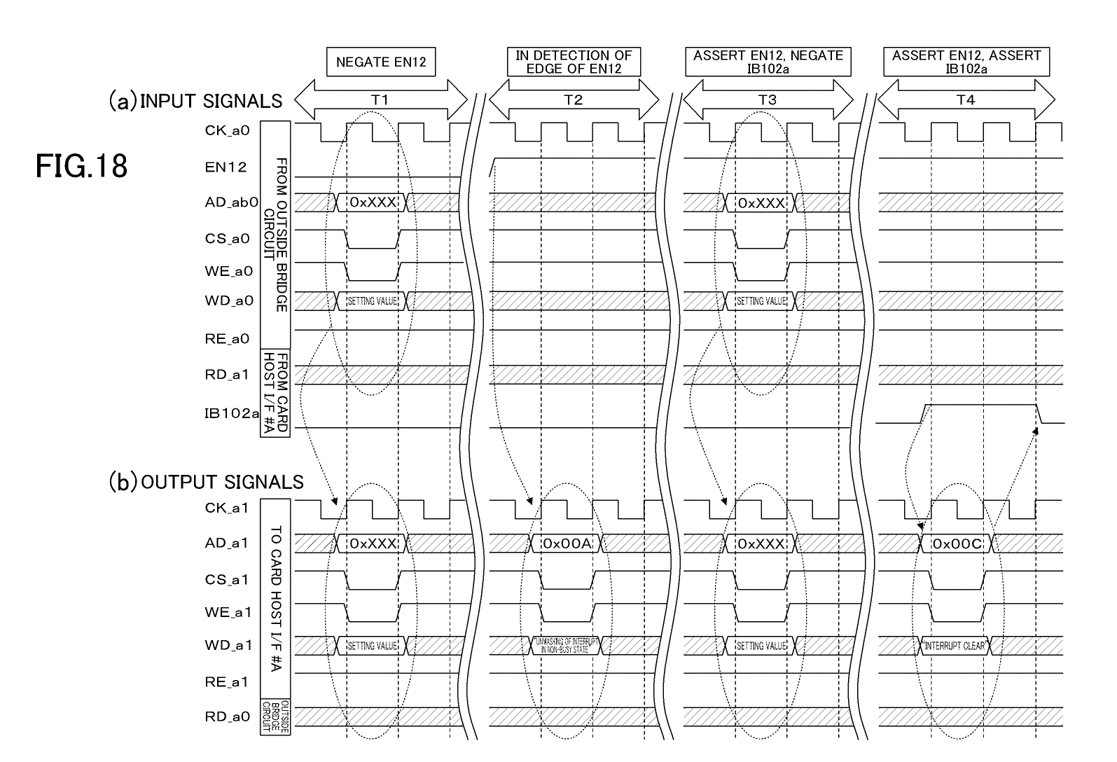

FIG. 17 illustrates a detailed configuration of the #A access control circuit 613. As shown in FIG. 17, the #A access control circuit 613 includes an #A signal generation circuit 615, and selectors 616a, 616b, 616c, 616d, 616e, 616f, and 616g.

FIGS. 18A and 18B are timing charts illustrating operation of the #A access control circuit 613. FIG. 18A illustrates input signals to the #A access control circuit 613. FIG. 18B illustrates output signals from the #A access control circuit 613. Time periods T1, T2, T3, and T4 represent when the enable signal EN12 is negated, when an edge of the enable signal EN12 is detected, when the enable signal EN12 is asserted and the interrupt IB102a in a non-busy state is negated, and when the enable signal EN12 is asserted and the interrupt IB102a in a non-busy state is asserted, respectively.

When the enable signal EN12 is negated (time period T1), the selectors 616a, 616b, 616c, 616d, 616e, 616f, and 616g respectively select the input signals CK_a0, AD_ab0, CS_a0, WE_a0, WD_a0, RE_a0, and RD_a1 (allow the signals to pass) and output as the signals CK_a1, AD_a1, CS_a1, WE_a1, WD_a1, RE_a1, and RD_a0.

When an edge of the enable signal EN12 is detected (time period T2), the #A signal generation circuit 615 generates signals for “masking/unmasking of an interrupt in a non-busy state.” The selectors 616a, 616b, 616c, 616d, 616e, and 616f output the signals generated by the #A signal generation circuit 615 as the signals CK_a1, AD_a1, CS_a1, WE_a1, WD_a1, and RE_a1. The signals for “masking/unmasking of an interrupt in a non-busy state” are: the address AD_a1 is “0x00A,” the chip enable signal CS_a1 is asserted, the write enable signal WE_a1 is asserted, and the read enable signal RE_a1 is negated at a rising edge of the clock signal CK_a1. The write data signal WD_a1 indicates “unmasking of an interrupt in a non-busy state” when the enable signal EN12 is changed from 0 (negated) to 1 (asserted), and “masking of interrupts in a non-busy state” when the enable signal EN12 is changed from 1 (asserted) to 0 (negated).

When the enable signal EN12 is asserted and the interrupt IB102a in a non-busy state is negated (time period T3), the selectors 616a, 616b, 616c, 616d, 616e, 616f, and 616g select the input signals CK_a0, AD_ab0, CS_a0, WE_a0, WD_a0, RE_a0, and RD_a1 (allow the signals to pass) and output as the signals CK_a1, AD_a1, CS_a1, WE_a1, WD_a1, RE_a1, and RD_a0.

When the enable signal EN12 is asserted and the interrupt IB102a in a non-busy state is asserted (time period T4), the #A signal generation circuit 615 generates signals for setting a “non-busy state.” The selectors 616a, 616b, 616c, 616d, 616e, and 616f output the signals generated by the #A signal generation circuit 615 as the signals CK_a1, AD_a1, CS_a1, WE_a1, WD_a1, and RE_a1. With respect to the signals for setting a “non-busy state,” the address AD_al is “0x00C,” the chip enable signal CS_a1 is asserted, the write enable signal WE_a1 is asserted, the write data signal WD_a1 indicates “interrupt clear,” and the read enable signal RE_a1 is negated at a rising edge of the clock signal CK_a1.

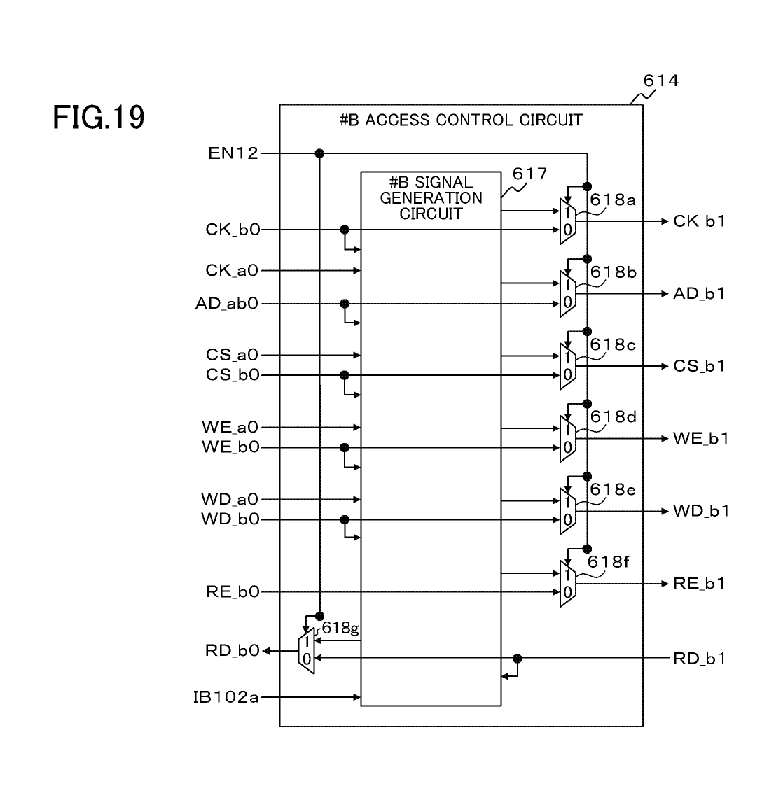

FIG. 19 illustrates a detailed configuration of the #B access control circuit 614. As shown in FIG. 19, the #B access control circuit 614 includes a #B signal generation circuit 617, and selectors 618a, 618b, 618c, 618d, 618e, 618f, and 618g.

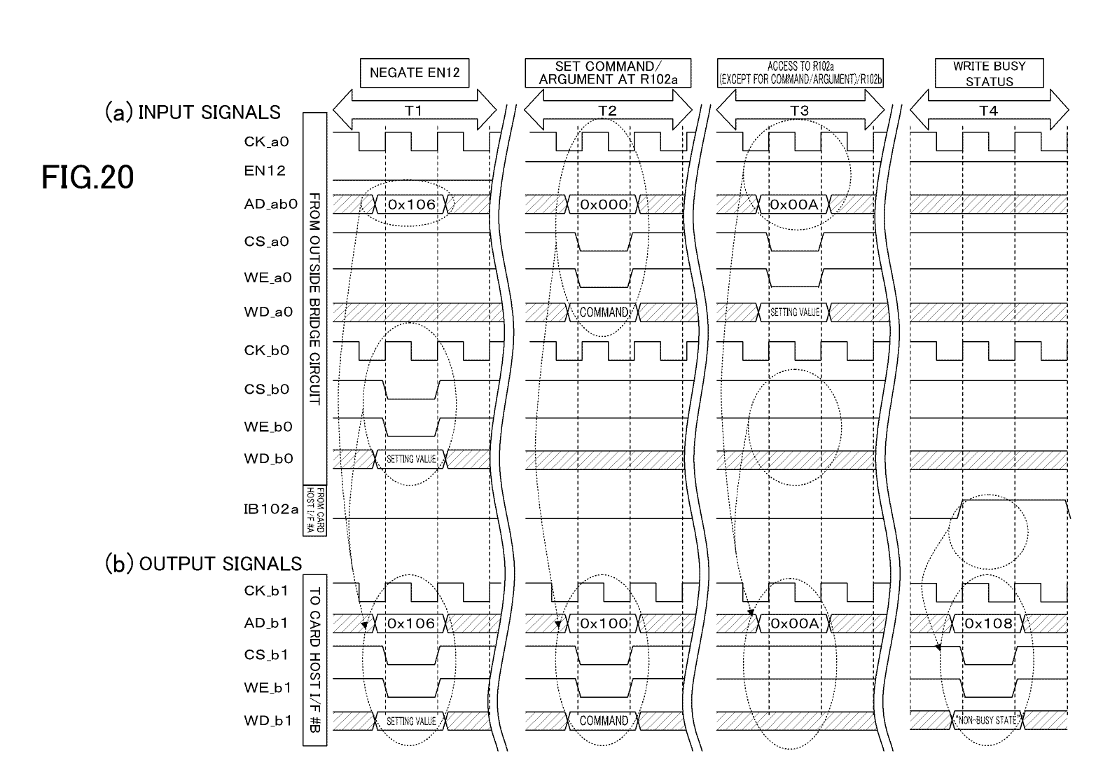

FIGS. 20A and 20B are timing charts illustrating operation of the #B access control circuit 614. FIG. 20A illustrates input signals to the #B access control circuit 614. FIG. 20B illustrates output signals from the #B access control circuit 614. Time periods T1, T2, T3, and T4 represent when the enable signal EN12 is negated, when a command/command argument at the register R102a is set, when the register R102a is accessed other than the control of the command/command argument or the register R102b is accessed, and when the busy status is written. In each of the time periods T2, T3, and T4, an enable signal EN is asserted.

When the enable signal EN12 is negated (time period T1), the selectors 618a, 618b, 618c, 618d, 618e, 618f, and 618g respectively select the input signals CK_b0, AD_ab0, CS_b0, WE_b0, WD_b0, RE_b0, and RD_b1 (allow the signals to pass) and output as the signal CK_b1, AD_b1, CS_b1, WE_b1, WD_b1, RE_b1, and RD_b0.

When a command/command argument at the register R102a is set (time period T2), the selectors 618a, 618c, 618d, and 618e respectively select the input signals CK_a0, CS_a0, WE_a0, and WD_a0, and output as the signals CK_b1, CS_b1, WE_b1, and WD_b1. The selector 618b outputs the address converted by the #B signal generation circuit 617 to a address “AD_ab0+0x100” for setting a command/command argument at the register R102b as AD_b1.

In read/write access to the register R102a other than the control of a command/command argument, or in read/write access to the register R102b (time period T3), the selectors 618a, 618b, 618c, 618d, and 618e respectively select the input signals CK_a0, AD_ab0, CS_b0, WE_b0, and WD_b0, and output as the signals CK_b1, AD_b1, CS_b1, WE_b1, and WD_b1.

When the interrupt IB 102a in a non-busy state is asserted (time period T4), the #B signal generation circuit 617 generates the signal for writing the busy status of the “non-busy state” to the register R102b. The selectors 618a, 618b, 618c, 618d, and 618e select and output the signals generated by the #B signal generation circuit 617 to the card host I/F 102b.

The signal for writing the busy status of the “non-busy state” is: the address AD_b1 is “0x108,” the chip enable signal CS_b1 is asserted, the write enable signal WE_b1 is asserted, and the write data signal WD_b1 indicates a “non-busy state” at a rising edge of the clock signal CK_b1. Note that, the clock signal CK_a0 is output as the clock signal CK_b1.

As described above, according to this embodiment, the plurality of card host I/Fs operate in a set in conjunction with each other to control a card module with a bit width different from a bit width of the individual card host I/Fs. This reduces redundant data lines in the card bus, thereby reducing the number of the input and output terminals. Even when a plurality of card modules are coupled, an increase in the area can be mitigated and costs can be reduced.

While in this embodiment, the order of the bits are changed using the bit rearrangement circuit 13, the bit rearrangement circuit 13 may not be included. In this case, the main microcomputer 10 transmits data, of which the order of bits is changed, to the host I/F 11, thereby providing similar processing. The bridge circuit 606 may be provided between the card host I/Fs 102a and 102b, and the host I/F 11.

While in the above configuration, the bridge circuit 606 is provided separately from the card host I/Fs 102a and 102b, the bridge circuit may be included in a card host I/F.

The set device may not include any card slot, and the card host LSI 601 may control an embedded module. Also, the set device may include both of a card slot and an embedded module.

While in this embodiment, the MMC 105c for 8 bits can be inserted into the card slot S105a, it can be inserted into the card slot S105b.

While in this embodiment, two card host I/Fs for 4-bit card modules control an 8-bit card module, the present disclosure is not limited thereto. For example, similar to this embodiment, the configuration can be achieved, in which two card host I/Fs for 8-bit card modules control a 16-bit card module. Alternately, similar to this embodiment, the configuration can be achieved, in which four card host I/Fs for 2-bit card modules control an 8-bit card module. That is, similar to this embodiment, the configuration can be achieved, in which M card host I/Fs, where M is an integer of 2 or more, for N-bit card modules, where N is an integer of 1 or more, control an (M×N)-bit card module.

Similar to the second embodiment, a card host LSI may include a plurality of sets of the M card host I/Fs, the M card bus terminals, and the bridge circuit, which are shown in this embodiment. For example, in an 8-bit mode, a second card host IF other than the M card host I/Fs may control another card module via unused one(s) of the card bus terminals.

Similar to the third embodiment, a high-speed startup sequencer may be provided, which starts in turning on the card host LSI. The high-speed startup sequencer may determine whether or not the (M×N)-bit card module is coupled to the card host LSI, and when coupled, sets the enable signal stored in the enable register to indicate the (M×N)-bit mode. The high-speed startup sequencer may set the enable signal stored in the enable register not to indicate the (M×N)-bit mode, when another card module is coupled to the card host LSI together with the (M×N)-bit card module.

The main microcomputer 10 may not set the card host LSI to the (M×N)-bit mode, when another card module is coupled to the card host LSI together with the (M×N)-bit card module.

### Fifth Embodiment

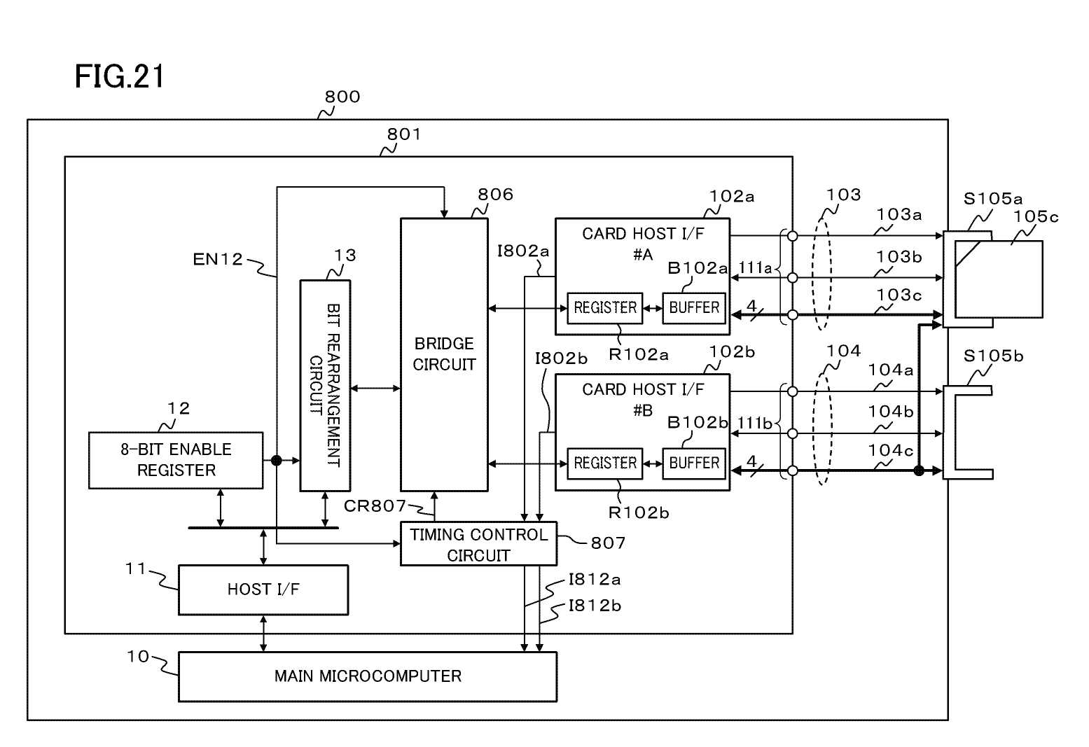

FIG. 21 illustrates a configuration of a set device according to a fifth embodiment. In FIG. 21, the same reference characters as those shown in FIG. 13 are used to represent equivalent elements, and the explanation thereof will be omitted.

As shown in FIG. 21, a set device 800 includes a main microcomputer 10, a card host LSI 801, card busses 103 and 104, and card slots S105a and S105b. Similar to the card host LSI 601 of FIG. 13, the card host LSI 801 has the function of controlling a plurality of card modules. The card host LSI 801 also accepts 8-bit card modules. FIG. 21 illustrates that an MMC 105c for 8 bits are inserted into the card slot S105a in the set device 800.

The card host LSI 801 differs from the card host LSI 601 of FIG. 13 in including a timing control circuit 807. The timing control circuit 807 receives interrupt signals I802a and I802b output from the card host I/Fs 102a and 102b, respectively, outputs new interrupt signals I812a and I812b for the card host I/Fs outside the card host LSI 801, and outputs an interrupt clear signal CR807 to a bridge circuit 806. The timing control circuit 807 receives an enable signal EN12.

The bridge circuit 806 has a similar configuration to that of the bridge circuit 606 of FIG. 13 but receives the interrupt clear signal CR807.

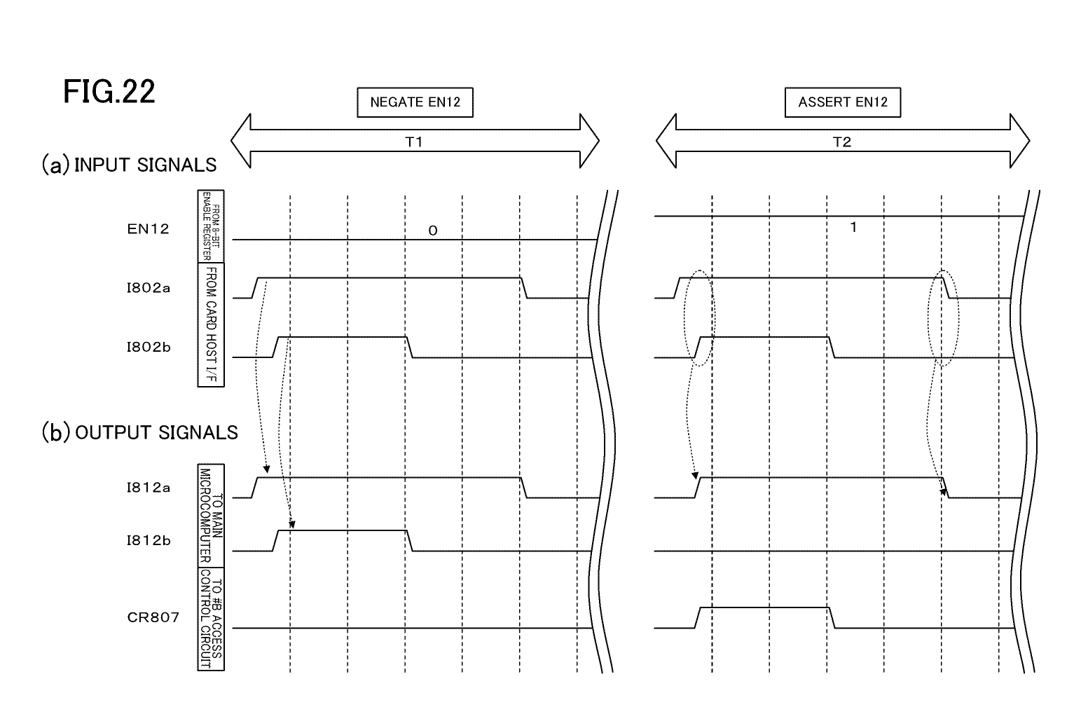

FIGS. 22A and 22B are timing charts illustrating operation of the timing control circuit 807. FIG. 22A illustrates input signals to the timing control circuit 807. FIG. 22B illustrates output signals from the timing control circuit 807. Time periods T1 and T2 represent when the enable signal EN12 is negated, and when the enable signal EN12 is asserted.

When the enable signal EN12 is negated (time period T1), the interrupt signals I802a and 1802b are through-output as the new interrupt signals I812a and I812b. At this time, the interrupt clear signal CR807 is always negated.

When the enable signal EN12 is asserted (time period T2), interrupts from the card host I/F 102b are set so that read/write requests are notified in addition to an error interrupt of transmitted data. When the interrupts are both read requests or write requests, the timing control circuit 807 asserts only the new interrupt signal I812a after the interrupt signals I802a and 1802b are asserted, and does not assert the new interrupt signal I812b. The timing control circuit 807 also asserts the interrupt clear signal CR807. The #B access control circuit 614 of the bridge circuit 806 clears the interrupt cause at the address 0x10C of the register R102b in response to the assertion of the interrupt clear signal CR807. When the interrupt signals I802a and 1802b are both negated, the timing control circuit 807 negates the new interrupt signal I812a.

When an interrupt is not a read/write request, the timing control circuit 807 through-outputs the interrupt signals I802a and I802b as the new interrupt signals I812a and I812b.

As described above, according to this embodiment, when the plurality of card host I/Fs operate in a set in conjunction with each other, a difference in processing timing can be detected and synchronized, even if the difference occurs among the card host I/Fs.

### Sixth Embodiment

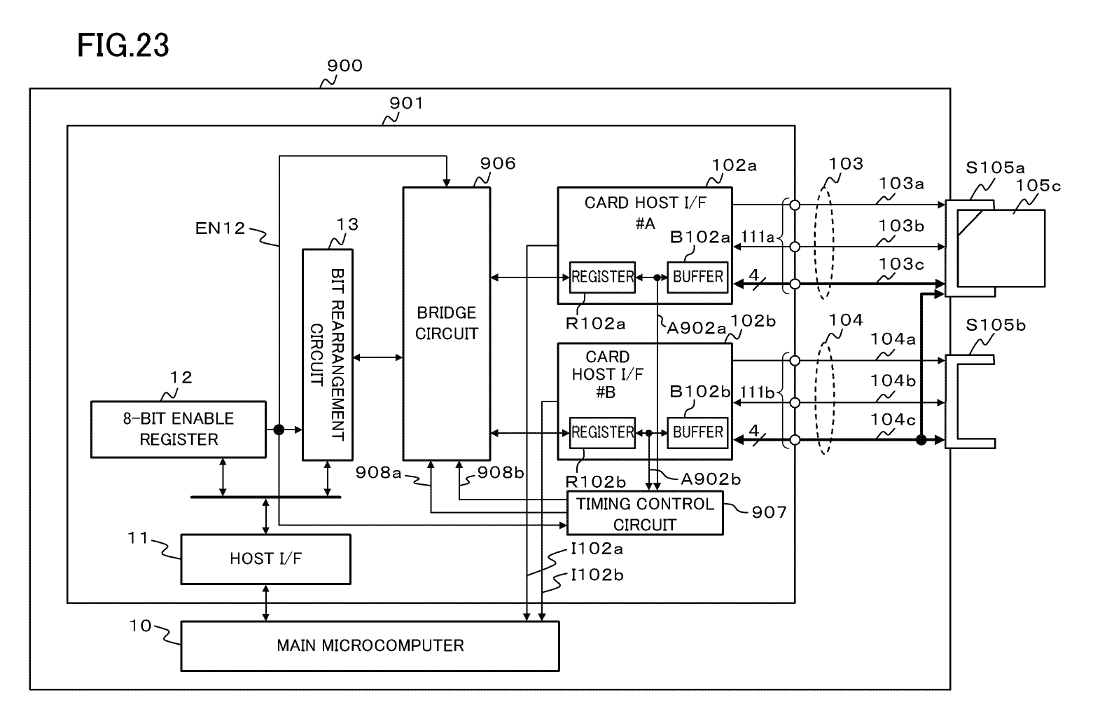

FIG. 23 illustrates a configuration of a set device according to a sixth embodiment. In FIG. 23, the same reference characters as those shown in FIG. 13 are used to represent equivalent elements, and the explanation thereof will be omitted.

As shown in FIG. 23, a set device 900 includes a main microcomputer 10, a card host LSI 901, card busses 103 and 104, and card slots S105a and S105b. Similar to the card host LSI 601 of FIG. 13, the card host LSI 901 has the function of controlling a plurality of card modules. The card host LSI 901 also accepts 8-bit card modules. FIG. 23 illustrates that an MMC 105c for 8 bits is inserted into the card slot S105a in the set device 900. The card host LSI 901 differs from the card host LSI 601 of FIG. 13 in including a timing control circuit 907. The timing control circuit 907 receives buffer address pointers A902a and A902b output from the card host I/Fs 102a and 102b, respectively, and outputs clock stop signals 908a and 908b for the card host I/Fs 102a and 102b to a bridge circuit 906. The buffer address pointers A902a and A902b increment a buffer starting address or a designated address by one. The timing control circuit 907 receives an enable signal EN12.

The bridge circuit 906 has the same similar configuration as the bridge circuit 606 of FIG. 13 but receives the clock stop signals clock 908a and 908b.

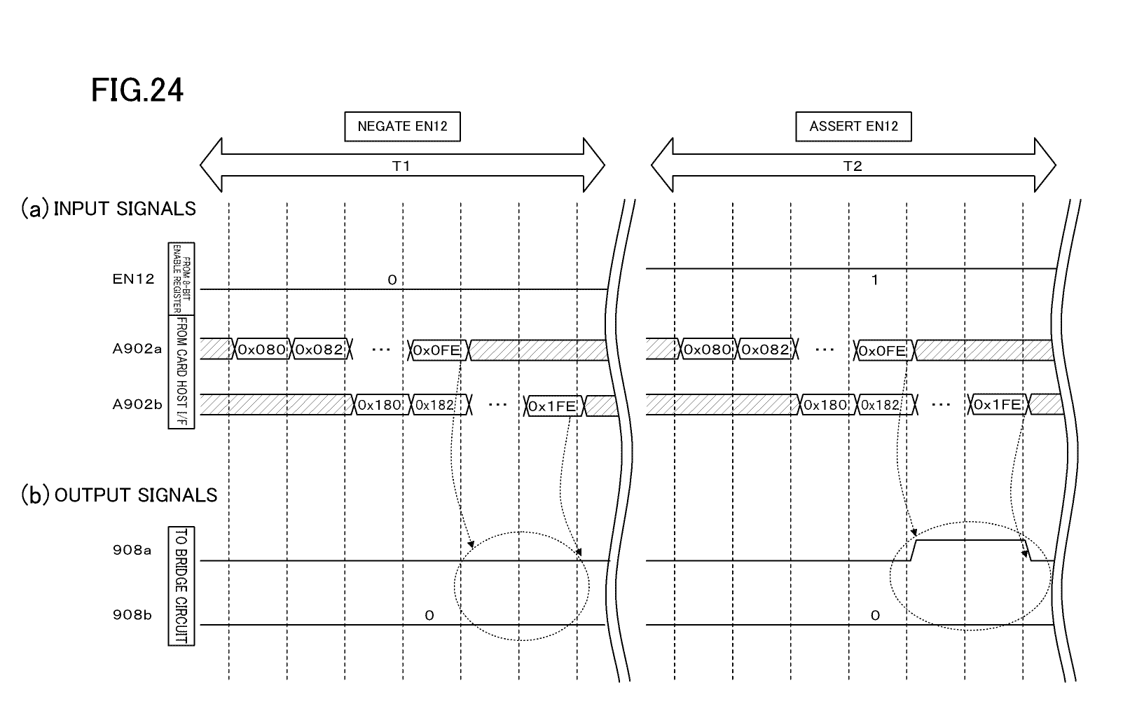

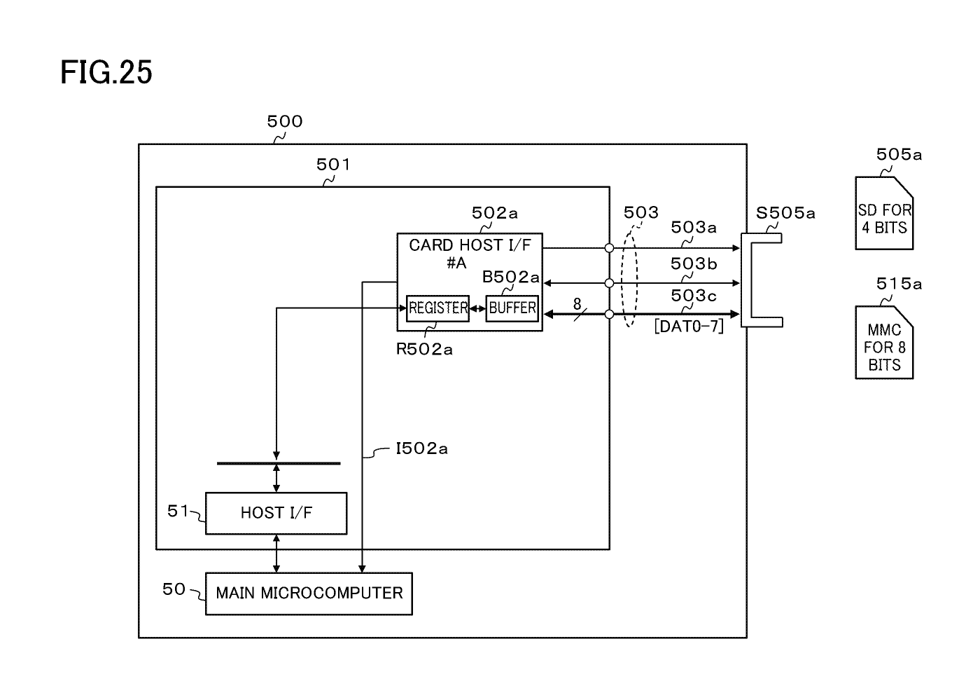

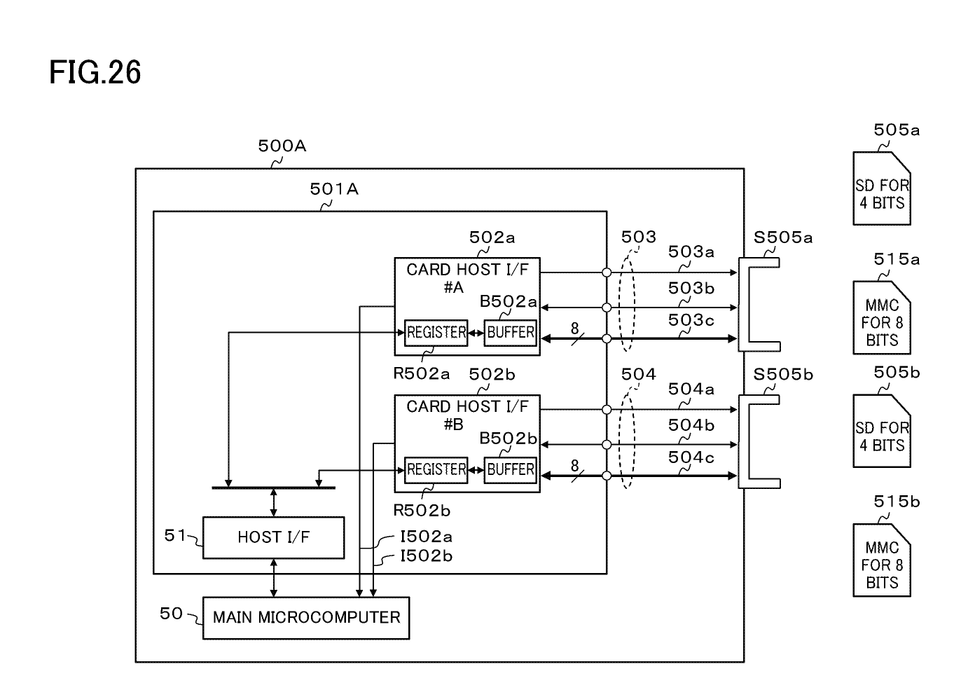

FIGS. 24A and 24B are timing charts illustrating operation of the timing control circuit 907. FIG. 24A illustrates input signals to the timing control circuit 907. FIG. 24B illustrates output signals from the timing control circuit 907. Time periods T1 and T2 represent when the enable signal EN12 is negated, and when the enable signal EN12 is asserted.

When the enable signal EN12 is negated (time period T1), the timing control circuit 907 does not monitor the buffer address pointers A902a and A902b. Thus, the clock stop signals 908a and 908b are always negated.

When the enable signal EN12 is asserted (time period T2), the timing control circuit 907 monitors the buffer address pointers A902a and A902b, and asserts the clock stop signal 908a or 908b for the card host I/F which reaches a full buffer address or a designated address earlier. When the clock stop signal 908a or 908b is asserted, the bridge circuit 906 stops a clock to the card host I/F 102a or 102b corresponding to the clock stop signal 908a or 908b, in which processing progresses. When both of the buffer address pointers A902a and A902b reach the full buffer address or the designated address, the timing control circuit 907 negates the clock stop signal 908a or 908b, which has been asserted earlier. This restarts processing of the card host I/F in which the clock is stopped.

As described above, according to this embodiment, when the plurality of card host I/Fs operate in a set in conjunction with each other, a difference in processing timing can be detected and synchronized, even if the difference occurs among the card host I/Fs.

Similar to the first to third embodiments, the fourth to sixth embodiments can be easily expanded to the following configurations. Specifically, the card host LSI includes M card host I/Fs, where M is an integer of two or more, for Ni-bit card modules, where i ranges from 1 to M and Ni is an integer of 1 or more; M card bus terminals; a host I/F; and a bridge circuit provided between the M card host I/Fs and the host I/F, providing the M card host I/Fs with a control signal received via the host I/F, and controlling the M card host I/Fs. The bridge circuit receives an enable signal indicating whether or not the card host LSI is in an L-bit mode, where L is an integer of two or more, for controlling an L-bit card module with a plurality of card host I/Fs. When the enable signal indicates the L-bit mode, the bridge circuit sets the M card host I/Fs so that the card host I/F corresponding to a card bus coupled to the L-bit card module and the other card host I/F(s) operate in conjunction with each other to control the L-bit card module.

The present disclosure provides a set device including a card host LSI which controls a plurality of removable cards or embedded modules without sacrificing reduction in the size and weight, and is thus useful for reducing the size and weight of, e.g., a mobile phone terminal and expanding the function.

What is claimed is:

1. A card host LSI having a function of controlling a plurality of card modules each of which is a removable card or an embedded module, the card host LSI comprising:
M card host I/Fs, where M is an integer of two or more, for N-bit card modules, where N is an integer of one or more, and controlled from outside the card host LSI;
M card bus terminals respectively corresponding to the M card host I/Fs and respectively coupled to M card busses outside the card host LSI; and
a bridge circuit provided between the M card host I/Fs and the M card bus terminals and configured to set coupling relationship of signal lines between the M card host I/Fs and the M card bus terminals, wherein
the bridge circuit receives an enable signal indicating whether or not the card host LSI is in an (M×N)-bit mode for controlling an (M×N)-bit card module, and sets the coupling relationship of the signal lines so that a first card host I/F corresponding to a card bus coupled to the (M×N)-bit card module and the other card host I/F(s) operate in conjunction with each other to control the (M×N)-bit card module, when the enable signal indicates the (M×N)-bit mode.

2. The card host LSI of claim 1, wherein
each of the card busses includes as signal lines, a data line for transmitting and receiving data, a command line for transmitting a command and receiving a response, and a clock line for transmitting a clock, and
the bridge circuit sets the coupling relationship of the signal lines so that a clock and a command output from the card host I/F(s) other than the first card host I/F are not transmitted to the card busses, when the enable signal indicates the (M×N)-bit mode.

3. The card host LSI of claim 1, wherein
each of the card busses includes as signal lines, a data line for transmitting and receiving data, a command line for transmitting a command and receiving a response, and a clock line for transmitting a clock, and
the bridge circuit sets the coupling relationship of the signal lines so that a response from the (M×N)-bit card module is returned to the first card host I/F as well as the other card host I/F(s), when the enable signal indicates the (M×N)-bit mode.

4. The card host LSI of claim 1, wherein
each of the M card host I/Fs includes a response determination circuit configured to determine validity of a response to a command, and
the function of the response determination circuit in the card host I/F(s) other than the first card host I/F is disabled in the (M×N)-bit mode.

5. The card host LSI of claim 1, wherein
the card host I/F(s) other than the first card host I/F is/are set to notify only an error interrupt of transmitted data among occurring interrupts in the (M×N)-bit mode.

6. The card host LSI of claim 1, wherein
each of the card busses includes as signal lines, a data line for transmitting and receiving data, a command line for transmitting a command and receiving a response, and a clock line for transmitting a clock, and
the bridge circuit sets the coupling relationship of the signal lines so that status information indicating a status of the (M×N)-bit card module is returned to the first card host I/F as well as the other card host I/F(s), when the enable signal indicates the (M×N)-bit mode.

7. The card host LSI of claim 1, further comprising:
a host I/F configured to receive a control signal from outside the card host LSI; and
a bit rearrangement circuit provided between the host I/F and the M card host I/Fs, wherein
the bit rearrangement circuit receives the enable signal, and rearranges bits of data written to the M card host I/Fs via the host I/F so that the first card host I/F and the other card host I/F(s) operate in conjunction with each other to write data to the (M×N)-bit card module, when the enable signal indicates the (M×N)-bit mode.

8. The card host LSI of claim 1, further comprising an enable register configured to store the enable signal.

9. The card host LSI of claim 8, further comprising
a high-speed startup sequencer starting in turning on the card host LSI, wherein
the high-speed startup sequencer determines whether or not the (M×N)-bit card module is coupled to the card host LSI, and when coupled, sets the enable signal stored in the enable register to indicate the (M×N)-bit mode.

10. The card host LSI of claim 9, wherein
the high-speed startup sequencer sets the enable signal stored in the enable register not to indicate the (M×N)-bit mode, when another card module is coupled to the card host LSI together with the (M×N)-bit card module.

11. The card host LSI of claim 1, wherein M=2.

12. The card host LSI of claim 1, further comprising:
two or more sets of the M card host I/Fs, the M card bus terminals, and the bridge circuit; and
a second card host I/F, wherein
the second card host I/F controls the card module via unused one(s) of the M card bus terminals in the (M×N)-bit mode.

13. A set device comprising:
the card host LSI of claim 1;
a main microcomputer configured to control the card host LSI; and
M card slots or M embedded modules respectively coupled to the M card bus terminals of the card host LSI.

14. The set device of claim 13, wherein
the main microcomputer does not set the card host LSI to the (M×N)-bit mode, when another card module is coupled to the card host LSI together with the (M×N)-bit card module.

15. A card host LSI having a function of controlling a plurality of card modules each of which is a removable card or an embedded module, the card host LSI comprising:
M card host I/Fs, where M is an integer of two or more, for Ni-bit card modules, where i ranges from 1 to M and Ni is an integer of 1 or more, and controlled from outside the card host LSI;
M card bus terminals respectively corresponding to the M card host I/Fs and respectively coupled to M card busses outside the card host LSI; and
a bridge circuit provided between the M card host I/Fs and the M card bus terminals and configured to set coupling relationship of signal lines between the M card host I/Fs and the M card bus terminals, wherein
the bridge circuit receives an enable signal indicating whether or not the card host LSI is in an L-bit mode, where L is an integer of two or more, for controlling an L-bit card module with the plurality of card host I/Fs; and sets the coupling relationship of the signal lines so that a card host I/F corresponding to a card bus coupled to the L-bit card module and the other card host I/F(s) operate in conjunction with each other to control the L-bit card module, when the enable signal indicates the L-bit mode.

16. A card host LSI having a function of controlling a plurality of card modules each of which is a removable card or an embedded module, the card host LSI comprising:
M card host I/Fs, where M is an integer of 2 or more, for N-bit card modules, where N is an integer of 1 or more, and controlled from outside the card host LSI;
M card bus terminals respectively corresponding to the M card host I/Fs and respectively coupled to M card busses outside the card host LSI;
a host I/F configured to receive a control signal from outside the card host LSI; and
a bridge circuit provided between the M card host I/Fs and the host I/F, configured to provide the M card host I/Fs with the control signal received via the host I/F, and configured to perform setting of the M card host I/Fs, wherein
the bridge circuit receives an enable signal indicating whether or not the card host LSI is in an (M×N)-bit mode for controlling an (M×N)-bit card module, and sets the M card host I/Fs so that a first card host I/F corresponding to a card bus coupled to the (M×N)-bit card module and the other card host I/F(s) operate in conjunction with each other to control the (M×N)-bit card module, when the enable signal indicates the (M×N)-bit mode.

17. The card host LSI of claim 16, further comprising
a timing control circuit configured to receive interrupt signals respectively output from the M card host I/Fs, output new interrupt signals for the respective card host I/Fs outside the card host LSI, and receive the enable signal, wherein
the timing control circuit asserts only the new interrupt signal for the first card host I/F, when the enable signal indicates the (M×N)-bit mode, an interrupt is a write request or a read request, and all the interrupt signals output from the M card host I/Fs are asserted.

18. The card host LSI of claim 16, wherein
each of the M card host I/Fs includes a buffer,
the card host LSI further includes a timing control circuit configured to receive buffer address pointers respectively output from the M card host I/Fs, output clock stop signals for the respective card host I/Fs to the bridge circuit, and receive the enable signal, and
the timing control circuit asserts each of the clock stop signals for the card host I/Fs, in which the buffer address pointer reaches a full buffer address or a designated address, until all the buffer address pointers output from the M card host I/Fs reach the full buffer address or the designated address, when the enable signal indicates the (M×N)-bit mode.

19. The card host LSI of claim 16, wherein
the bridge circuit sets the card host I/F(s) other than the first card host I/F not to output a clock when the enable signal indicates the (M×N)-bit mode.

20. The card host LSI of claim 16, wherein
each of the M card host I/Fs includes a response determination circuit configured to determine validity of a response to a command, and
the bridge circuit disables the function of the response determination circuit in the card host I/F(s) other than the first card host I/F, when the enable signal indicates the (M×N)-bit mode.

21. The card host LSI of claim 16, wherein
the bridge circuit sets the card host I/F(s) other than the first card host I/F to notify only an error interrupt of transmitted data among occurring interrupts, when the enable signal indicates the (M×N)-bit mode.

22. The card host LSI of claim 16, wherein
the bridge circuit sets status information indicating a status of the (M×N)-bit card module to be shared by the first card host I/F and the other card host I/F(s), when the enable signal indicates the (M×N)-bit mode.

23. The card host LSI of claim 16, further comprising
a bit rearrangement circuit provided between the host I/F and the bridge circuit, wherein
the bit rearrangement circuit receives the enable signal, and rearranges bits of data written into the M card host I/Fs via the host I/F so that the first card host I/F and the other card host I/F(s) operate in conjunction with each other to write data to the (M×N)-bit card module, when the enable signal indicates the (M×N)-bit mode.

24. The card host LSI of claim 16, further comprising an enable register configured to store the enable signal.

25. The card host LSI of claim 24, further comprising
a high-speed startup sequencer starting in turning on the card host LSI, wherein
the high-speed startup sequencer determines whether or not the (M×N)-bit card module is coupled to the card host LSI, and when coupled, sets the enable signal stored in the enable register to indicate the (M×N)-bit mode.

26. The card host LSI of claim 25, wherein
the high-speed startup sequencer sets the enable signal stored in the enable register not to indicate the (M×N)-bit mode, when another card module is coupled to the card host LSI together with the (M×N)-bit card module.

27. The card host LSI of claim 16, wherein M=2.

28. The card host LSI of claim 16, further comprising:
two or more sets of the M card host I/Fs, the M card bus terminals, and the bridge circuit; and
a second card host I/F, wherein
the second card host I/F controls the card module via unused one(s) of the M card bus terminals in the (M×N)-bit mode.

29. A set device comprising:
the card host LSI of claim 16;
a main microcomputer configured to control the card host LSI; and
M card slots or M embedded modules respectively coupled to the M card bus terminals of the card host LSI.

30. The set device of claim 29, wherein
the main microcomputer does not set the card host LSI to the (M×N)-bit mode, when another card module is coupled to the card host LSI together with the (M×N)-bit card module.

31. A card host LSI having a function of controlling a plurality of card modules each of which is a removable card or an embedded module, the card host LSI comprising:
M card host I/Fs, where M is an integer of two or more, for Ni-bit card modules, where i ranges from 1 to M and Ni is an integer of 1 or more, and controlled from outside the card host LSI;
M card bus terminals respectively corresponding to the M card host I/Fs and respectively coupled to M card busses outside the card host LSI;
a host I/F configured to receive a control signal from outside the card host LSI; and
a bridge circuit provided between the M card host I/Fs and the host I/F, configured to provide the M card host I/Fs with the control signal received via the host I/F, and configured to perform setting of the M card host I/Fs, wherein
the bridge circuit receives an enable signal indicating whether or not the card host LSI is in an L-bit mode, where L is an integer of two or more, for controlling an L-bit card module with the plurality of card host I/Fs and sets the M card host I/Fs so that a card host I/F corresponding to a card bus coupled to the L-bit card module and the other card host I/F(s) operate in conjunction with each other to control the L-bit card module, when the enable signal indicates the L-bit mode.
